(19) United States
(12) Patent Application Publication
(10) Pub. No.: US 2023/0363410 A1
(43) Pub. Date: Nov. 16, 2023

(54) PLANT-BASED MEAT REPLICAS WITH BINDERS FOR PLANT-BASED FOOD PRODUCTS

(71) Applicant: Epogge, LLC, Indianapolis, IN (US)

(72) Inventors: David Rowe, Indianapolis, IN (US); Aaron Milhouse, Pendleton, SC (US)

(73) Assignee: Epogee, LLC, Indianapolis, IN (US)

(21) Appl. No.: 18/360,022

(22) Filed: Jul. 27, 2023

Related U.S. Application Data
(63) Continuation of application No. PCT/US2022/014295, filed on Jan. 28, 2022.
(60) Provisional application No. 63/199,842, filed on Jan. 28, 2021.

(51) Int. Cl. A23J 3/22; A23J 3/14

(52) U.S. Cl. CPC A23J 3/227; A23J 3/14

(57) ABSTRACT

Plant-based food products comprising enhanced binding agents, and reduced fat and calories.

### CROSS REFERENCE TO RELATED APPLICATION

This application is a continuation of International Application No. PCT/US2022/014295 filed Jan. 28, 2022, the entirety of which is hereby incorporated by reference herein in its entirety. International Application No. PCT/US2022/014295 claims the right of priority to U.S. Provisional Pat. Application number 63/199,842 filed on Jan. 28, 2021, the entirety of which is hereby incorporated by reference herein in its entirety.

### FIELD

The present disclosure relates to meat replicas, such as ground meat replicas, and more particularly to plant-based products that mimic the texture, appearance, and sensory aspects of ground meat. This disclosure also generally relates to compositions and methods for altering the calorie content, fat content, taste, and binding properties of plant-based food products.

### BACKGROUND

Common limitations associated with plant products such as plant-based meat substitutes include the requirement to use varying amounts of binding agents. Given that many plant-based meats are designed to avoid suitable animal-based binders such as egg and gelatin in an effort to appease vegan diets, such products are left to be formulated with a higher volume of plant-based binders such as gluten and conglycinin (known allergens) and synthetic binders like methylcellulose (a known laxative). Moreover, such plant-based meat products typically contain >15 wt.% in total fat content, meaning these products often have a higher fat and calorie content when compared to their meat-based counterparts. As a result, these products mainly appeal to a limited consumer base that is already committed to vegetarianism/veganism but have failed to appeal to the larger consumer segment accustomed to eating meat.

The source proteins for most plant-based products are typically comprised of isolated pea, soy, or a combination of the two products, though other types of isolated proteins like grain (seitan), tree nut, or mushroom may be utilized depending on the application. When used, each of these different protein sources can impart unique properties and flavors, both positive and negative. Regarding negatives, the most notable attribute is typically the detection of unexpected flavor notes not found in their true meat counterparts, such as “beany” or “bitter.” Additionally, the use of large quantities of these concentrated proteins can result in an inherent dryness and/or graininess in the final food product.

Accordingly, there remains a need for improved plant-based meat substitutes which include the use of novel binders that can simultaneously reduce fat content and the amount of carbohydrate-based binders.

### SUMMARY

The present disclosure relates to methods and materials for making low-fat plant-based products having an esterified alkoxylated polyols as a primary binder. In certain embodiments, the plant-based products can mimic ground meat, including the fibrousness, heterogeneity in texture, beefy or other meat flavor, and red-to-brown color transition during cooking of ground meat, without off flavors. For example, this disclosure provides meat replicas that include proteins that are selected based upon the temperature at which they gel and/or denature to replicate the behavior and qualities of meat during cooking, i.e., the firming, syneresis (water release), chew texture, or mouthfeel. For example, the temperature of denaturing and gelling of the proteins selected to be in the meat replica can be similar to that of proteins typically found in meat (e.g., actin and myosin). Further the plant-based products provided herein can include flavoring agents (e.g., flavorings, flavoring precursors, and/or flavoring compounds) that can provide meaty flavors, such that a plant-based meat replica has a more natural flavor and does not have off flavors.

More specifically, the present disclosure describes plant-based food products that contain novel plant-based synthetic binders that can be used to supplement or, in some instances, replace carbohydrate-based binders. In certain embodiments, these binders comprise fat mimetics, which can simultaneously (i) provide enhanced binding structure to the food product and (ii) replace or reduce the amount of fats used in the food product in an effort to reduce overall calories and fat content. In certain embodiments, the binders comprise an esterified alkoxylated polyol, such as an esterified propoxylated glycerin (“EPG”).

In one aspect, the present disclosure relates to plant-based food products, including plant-based meat replicas. In certain embodiments, the plant-based food product comprises: a plant-based dough comprising an edible fibrous component; a flavor agent; and a primary binder comprising an esterified alkoxylated polyol. In certain embodiments, the esterified alkoxylated polyol comprises an EPG. In certain embodiments, the food product further comprises a secondary binder. In certain embodiments, the secondary binder comprises a plant-based carbohydrate or a plant protein. In certain embodiments, the food product further comprises a heme-containing protein.

In certain embodiments, the food product comprises about 5% to about 88% (e.g., about 40% to about 88%, about 45% to about 60%, or about 15% to about 55%) by weight of a plant-based meat dough; about 0% to about 40% (e.g., about 1% to about 30%, about 5% to about 25%, or about 15% to about 25%) by weight of a carbohydrate-based gel; about 0% to about 10% (e.g., about 0.10% to about 5%, about 5% to about 8%, or about 8% to about 10%) by weight of a fat; about 1 to about 40% of a primary binding agent comprising an esterified alkoxylated polyol; about 0.00001% to about 10% (e.g., about 3% to about 7%, about 0.001% to about 2%, or about 0.00001% to about 2%) by weight of a flavoring agent; about 0% to about 10% (e.g., about 1% to about 8% or about 1% to about 5% by weight of a secondary binding agent; and about 0.01% to about 4% (e.g., about 0.05% to about 1%, or about 0.5% to about 2%) by weight of a heme-containing protein and/or an iron salt. The meat dough can include a flavoring agent. The fat can include a flavoring agent. The meat dough can be about 45% to about 60% by weight of the composition. The carbohydrate-based gel can be about 10% to about 25% by weight of the composition. The fat can be about 10% to about 15% by weight of the composition. The flavoring agent can be about 3% to about 7% or about 0.001% to about 2% by weight of the composition. The flavoring agent can include one or more flavor precursors, a flavoring, or a flavoring compound. The flavoring agent can be a combination of a flavoring and one or more flavor precursors. The secondary binding agent can be about 0.01% to about 10% by weight of the composition. The binding agent can include one or more proteins that have been chemically or enzymatically modified to improve their textural and/or flavor properties, or to modify their denaturation and gelling temperatures. The heme-containing protein can be about 0.01% to about 2% by weight of the composition. The composition can include the heme-containing protein and the iron salt. The meat dough can include an isolated plant protein, an edible fibrous component, an optional flavoring agent, and an optional fat. The binding agent can be a conglycinin protein.

In another aspect, this document features a plant-based meat replica composition that includes about 5% to about 80% (e.g., about 20% to about 30%) by weight of a meat dough; about 0% to about 15% (e.g., about 5% to about 10%) by weight of a fat; about 1 to about 40% (e.g., about 1 to about 10%) of a primary binding agent comprising an esterified alkoxylated polyol; about 15% to about 40% (e.g., about 15% to about 25%) by weight of an edible fibrous component; about 0% to about 18% (e.g., about 0.1% to about 15%) by weight of a carbohydrate-based gel; about 0% to about 10% (e.g., about 0% to about 10%) by weight of a flavoring agent; about 0% to about 15% (e.g., about 1% to about 10%) by weight of a secondary binding agent; and about 0.1% to about 8% (e.g., about 2% to about 8%) by weight of a heme-containing protein and/or an iron salt.

In another aspect, this document features a method of making a plant-based ground meat replica. The method can include (a) heating a dough to a temperature ranging from 150° F. to 250° F., the dough comprising an isolated plant protein, an optional edible fibrous component, one or more optional flavoring agents, and an optional fat; (b) combining the dough, after heating, with a fat and a primary binding agent such as EPG (or a blend of the two), either or both of which optionally containing a flavoring agent and/or an isolated plant protein; and (c) combining the dough from step (b) with a carbohydrate-based gel, an optional edible fibrous component, an optional binding agent, a highly conjugated heterocyclic ring complexed to an iron ion and/or an iron salt, and one or more optional flavoring agents to make the ground meat replica. The method can further include breaking the dough from step (b) into pieces before combining with the carbohydrate-based gel, the optional edible fibrous component, the optional binding agent, the highly conjugated heterocyclic ring complexed to an iron ion and/or the iron salt, and one or more optional flavoring agents.

In another aspect, this document features a method of flavoring a meat dough. The method can include (a) combining a first highly conjugated heterocyclic ring complexed to an iron ion and/or a first iron salt with one or more flavor precursors and an optional fat; (b) heating the mixture to form one or more flavor compounds; and (c) making a dough comprising an isolated plant protein, an optional edible fibrous component, and the mixture from step (b). The method can further include (d) combining the dough, after heating, with a fat and a primary binding agent such as EPG (or a blend of the two), either or both of which optionally contain a flavoring agent and/or an isolated plant protein; and (e) combining the dough of step (d) with a carbohydrate-based gel, an optional binding agent, a second highly conjugated heterocyclic ring complexed to an iron ion and/or a second iron salt, and one or more optional flavoring agents to make a ground meat replica. The method can further include breaking the dough from step (d) into pieces before combining with the carbohydrate-based gel, the optional binding agent, the second highly conjugated heterocyclic ring complexed to an iron ion and/or the second iron salt, and one or more optional flavoring agents.

In another aspect, this document features a method of flavoring a meat dough, where the method includes (a) making a dough comprising an isolated plant protein, an optional edible fibrous component, one or more optional flavoring agents, and an optional fat; (b) making a flavored fat mimetic blend by combining a primary binder (e.g., an EPG fat mimetic), optionally with a fat, either or both of which with a highly conjugated heterocyclic ring complexed to an iron ion and/or a first iron salt, and one or more flavor precursors and heating the mixture; and (c) combining the dough, after heating, with the flavored primary binder composition. The method can further include combining the dough of step (c) with a carbohydrate-based gel, an optional binding agent, a second highly conjugated heterocyclic ring complexed to an iron ion and/or a second iron salt, and one or more optional flavoring agents to make a ground meat replica. The method can further include breaking the dough of step (c) before combining with the carbohydrate-based gel, the optional binding agent, the second highly conjugated heterocyclic ring complexed to an iron ion and/or the second iron salt, and one or more optional flavoring agents.

This document also features a method of making a ground meat replica, where the method includes (a) combining an iron salt with one or more flavor precursors and an optional fat; (b) heating the mixture to form one or more flavor compounds; (c) making a dough comprising an isolated plant protein, an optional edible fibrous component, and the mixture from step (b); (d) combining the dough, after heating, with a primary binding agent such as EPG and, optionally, a fat (or a blend of the two), either or both of which optionally contain a flavoring agent and/or an isolated plant protein; and (e) combining the dough of step (d) with a carbohydrate-based gel, an optional secondary binding agent, an iron salt, an optional highly conjugated heterocyclic ring complexed to an iron ion, and one or more optional flavoring agents to make the ground meat replica. The method can further include breaking the dough from step (d) into pieces before combining with the carbohydrate-based gel, the optional secondary binding agent, the iron salt, the optional highly conjugated heterocyclic ring complexed to an iron ion, and one or more optional flavoring agents. In some embodiments, a highly conjugated heterocyclic ring complexed to an iron ion can be combined with the iron salt, the one or more flavor precursors, and the primary binder before heating the mixture.

In yet another aspect, this document features a method of making a ground meat replica. The method can include (a) making a dough comprising an isolated plant protein, an optional edible fibrous component, one or more optional flavoring agents, and an optional fat; (b) making a flavored primary binder blend by combining an esterified alkoxylated polyol (e.g., EPG, optionally with a fat added to form a fat/fat mimetic blend), with an iron salt and one or more flavor precursors and heating the mixture; (c) combining the dough, after heating, with the flavored primary binder; and (d) combining the dough of step (c) with a carbohydrate-based gel, an optional secondary binding agent, an iron salt, an optional highly conjugated heterocyclic ring complexed to an iron ion, and one or more optional flavoring agents to make the ground meat replica. The method can further include breaking the dough from step (c) before combining with the carbohydrate-based gel, the optional secondary binding agent, the iron salt, the optional highly conjugated heterocyclic ring complexed to an iron ion, and one or more optional flavoring agents. In some embodiments, a highly conjugated heterocyclic ring complexed to an iron ion can be combined with the primary binder, the iron salt, and the one or more flavor precursors before heating the mixture.

In any of the methods or compositions described herein, the iron salt can be iron gluconate, iron chloride, iron oxalate, iron nitrate, iron citrate, iron ascorbate, ferrous sulfate, ferric pyrophosphate, or any other aqueous soluble salt.

In any of the methods or compositions described herein, the heme-containing protein can be a non-animal heme-containing protein, such as a plant-derived heme-containing protein (e.g., leghemoglobin). Further, in some embodiments, the heme-containing protein can be isolated or isolated and purified.

In any of the methods or compositions described herein, the one or more flavor precursors can be a sugar, a sugar alcohol, a sugar acid, a sugar derivative, an oil, a free fatty acid, an amino acid or derivative thereof, a nucleoside, a nucleotide, a vitamin, an acid, a peptide, a phospholipid, a protein hydrolysate, a yeast extract, or a mixture thereof. For example, the flavor precursor can be selected from the group consisting of glucose, fructose, ribose, arabinose, glucose-6-phosphate, fructose 6-phosphate, fructose 1,6-diphosphate, inositol, maltose, sucrose, maltodextrin, glycogen, nucleotide-bound sugars, molasses, a phospholipid, a lecithin, inosine, inosine monophosphate (IMP), guanosine monophosphate (GMP), pyrazine, adenosine monophosphate (AMP), lactic acid, succinic acid, glycolic acid, thiamine, creatine, pyrophosphate, vegetable oil, algal oil, sunflower oil, corn oil, soybean oil, palm fruit oil, palm kernel oil, safflower oil, flaxseed oil, rice bran oil, cottonseed oil, olive oil, sunflower oil, canola oil, flaxseed oil, coconut oil, mango oil, a free fatty acid, cysteine, methionine, isoleucine, leucine, lysine, phenylalanine, threonine, tryptophan, valine, arginine, histidine, alanine, asparagine, aspartate, glutamate, glutamine, glycine, proline, serine, tyrosine, glutathione, an amino acid derivative, urea, pantothenic acid, ornithine, niacin, glycerol, citrulline, taurine, biotin, borage oil, fungal oil, blackcurrant oil, betaine, beta carotene, B-vitamins, N-Acetyl L-cysteine, iron glutamate and a peptone, or mixtures thereof.

In any of the methods or compositions described herein, the isolated plant protein in the dough can include wheat gluten, a dehydrin protein, an albumin, a globulin, or a zein, or mixtures thereof.

In any of the methods or compositions described herein, the optional edible fibrous component can include plant fibers from carrot, bamboo, pea, broccoli, potato, sweet potato, corn, whole grains, alfalfa, kale, celery, celery root, parsley, cabbage, zucchini, green beans, kidney beans, black beans, red beans, white beans, beets, cauliflower, nuts, apple skins, oats, wheat, or psyllium, or a mixture thereof.

In any of the methods or compositions described herein, the edible fibrous component can include an extruded mixture of isolated plant proteins. The extruded mixture can contain wheat gluten and soy protein isolate, and optionally can further contain a flavoring agent (e.g., a flavoring such as yeast extract, a protein hydrolysate, or an oil; a flavor compound; or a flavor precursor). In some embodiments, the edible fibrous component can be a solution-spun protein fiber (e.g., a solution-spun protein fiber containing a prolamin such as corn zein, pea prolamin, kafirin, secalin, hordein, avenin, or a mixture thereof).

In any of the methods or compositions described herein, the fat can be a non-animal fat, an animal fat, or a mixture of non-animal and animal fat. The fat can be an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, or rice bran oil; or margarine or other hydrogenated fats. In some embodiments, for example, the fat is algal oil. The fat can contain the flavoring agent and/or the isolated plant protein (e.g., a conglycinin protein).

In any of the methods or compositions described herein, the dough can include the flavoring agent. In any of the methods or compositions, the non-animal fat in the dough can include a flavoring agent. The flavoring agent can be selected from the group consisting of a vegetable extract, a fruit extract, an acid, an antioxidant, a carotenoid, a lactone, and combinations thereof. The antioxidant can be epigallocatechin gallate. The carotenoid can be lutein, (β-carotene, zeaxanthin, trans-β-apo-8′-carotenal, lycopene, or canthaxanthin. The vegetable extract can be from a cucumber or tomato. The fruit extract can be from a melon or pineapple.

In any of the methods or compositions described herein, the carbohydrate-based gel can have a melting temperature between about 45° C. and about 85° C. The carbohydrate-based gel can include agar, pectin, carrageenan, konjac, alginate, chemically-modified agarose, or mixtures thereof.

In any of the methods of compositions described herein, the plant-based food product can comprise a primary binder. In certain embodiments, the primary binder comprises an esterified alkoxylated polyol, such as an EPG. In certain embodiments, the primary binding agent (binder) may be introduced into the food product at any stage of the product’s production, either as a virgin material or blended with a fat (e.g., an 80/20 wt.% blend of EPG and a vegetable oil fat). In certain embodiments, the primary binder is solid at room temperature and is designed to melt (either as a virgin material or as a blend (e.g., eutectic blend) with a fat) at the body temperature of the consumer (e.g., about 36° C. or lower).

In any of the methods or compositions described herein, the ground meat replica can further contain a secondary binding agent. The secondary binding agent can be an isolated plant protein (e.g., a RuBisCO, an albumin, a gluten, a conglycinin, or mixtures thereof). The denaturation temperature of the secondary binding agent can be between about 40° C. and about 80° C. The secondary binding agent can be a carbohydrate based gel that becomes firm upon cooking to 140° F. to 190° F. The carbohydrate based gel can contain methylcellulose, hydroxypropylmethyl cellulose, guar gum, locust bean gum, xanthan gum, or a mixture thereof. The binding agent can be egg albumin or collagen.

In any of the methods or compositions described herein, the highly conjugated heterocyclic ring complexed to an iron ion can be a heme moiety, or a porphyrin, porphyrinogen, corrin, corrinoid, chlorin, bacteriochlorophyll, corphin, chlorophyllin, bacteriochlorin, or isobacteriochlorin moiety complexed to an iron ion. The heme moiety can be a heme-containing protein (e.g., a non-symbiotic hemoglobin, a Hell’s gate globin I, a flavohemoprotein, a leghemoglobin, a heme-dependent peroxidase, a cytochrome c peroxidase, or a mammalian myoglobin). In some embodiments, the heme-containing protein can be a leghemoglobin. The leghemoglobin can be from soybean, pea, or cowpea.

In another aspect, this disclosure features a method of increasing the meat flavor or masking off flavors from plant material in a food product. The method can include adding, to the food product, one or more lactones at a concentration of 10⁻³ to 10⁻¹¹ of the food product, wherein the lactones are selected from the group consisting of tetrahydro-6-methyl-2H-pyran-2-one, delta-octalactone, 5-ethyldihydro-2(3H)-furanone, butyrolactone, dihydro-5-pentyl-2(3H)-furanone, dihydro-3-methylene-2,5-furandione, 1-pentoyl lactone, tetrahydro-2H-pyran-2-one, 6-heptyltetrahydro-2H-pyran-2-one, γ-octalactone, 5-hydroxymethyldihydrofuran-2-one, 5-ethyl-2(5H)-furanone, 5-acetyldihydro-2(3H)-furanone, trans-3-methyl-4-octanolide 2(5H)-furanone, 3-(1,1-dimethylethyl)-2,5-urandione, 3,4-dihydroxy-5-methyl-dihydrofuran-2-one, 5-ethyl-4-hydroxy-2-methyl-3(2H)-furanone, δ-tetradecalactone, and dihydro-4-hydroxy-2(3H)-furanone. In some embodiments, the lactones can be 5-ethyl-4-hydroxy-2-methyl-3(2H)-furanone, butyrolactone, y-octalactone, and δ-tetmdecalactone. The food product can be a meat replica. The meat replica can be free of animal products.

This disclosure also features a method of increasing the meat flavor or masking off flavors from plant material in a food product, where the method includes adding, to the food product, one or more carotenoids at a concentration of between 0.00001% and 0.1% of the food product, wherein the carotenoids are selected from the group consisting of β-carotene, zeaxanthin, lutein, trans-β-apo-8′-carotenal, lycopene, canthaxanthin, and combinations thereof. The food product can be a meat replica. The meat replica can be free of animal products.

In another embodiment, this document features a method of increasing the meat flavor of a meat replica. The method can include adding, to the meat replica, a vegetable juice, a vegetable puree, a vegetable extract, a fruit juice, a fruit puree, or a fruit extract to the meat replica at a concentration from 0.0001% to 10% of the meat replica. The vegetable juice, vegetable puree, vegetable extract, a fruit juice, a fruit puree, or a fruit extract can be a Cucumis juice, puree, or extract (e.g., a juice, puree, or extract from a cucumber or a melon). The method vegetable juice, vegetable puree, vegetable extract, fruit juice, fruit puree, or fruit extract can be cooked or otherwise treated to denature proteins before adding to the meat replica. The meat replica can be free of animal products.

In another aspect, this document features a food product or food replica product containing a heme-containing protein and one or more lactones at a concentration of 10⁻³ to 10⁻¹¹ of the food product, wherein the one or more lactones are selected from the group consisting of tetrahydro-6-methyl-2H-pyran-2-one, delta-octalactone, 5-ethyldihydro-2(3H)-furanone, butyrolactone, dihydro-5-pentyl-2(3H)-furanone, dihydro-3-methylene-2,5-furandione, 1-pentoyl lactone, tetrahydro-2H-pyran-2-one, 6-heptyltetrahydro-2H-pyran-2-one, y-octalactone, 5-hydroxymethyldihydrofuran-2-one, 5-ethyl-2(5H)-furanone, 5-acetyldihydro-2(3H)-furanone, trans-3-methyl-4-octanolide 2(5H)-furanone, 3-(1,1-dimethylethyl)-2,5-urandione, 3,4-dihydroxy-5-methyl-dihydrofuran-2-one, 5-ethyl-4-hydroxy-2-methyl-3(2H)-furanone, δ-tetradecalactone, and dihydro-4-hydroxy-2(3H)-furanone. For example, the one or more lactones can be 5-ethyl-4-hydroxy-2-methyl-3(2H)-furanone, butyrolactone, y-octalactone, and δ-tetradecalactone. The food product or food replica product can be a meat replica. The meat replica can be free of animal products.

This document also features a food product or food replica product containing a heme-containing protein and one or more carotenoids at a concentration of between 0.00001% and 0.1% of the food product, wherein the one or more carotenoids are selected from the group consisting of β-carotene, zeaxanthin, lutein, trans-β-apo-8′-carotenal, lycopene, canthaxanthin, and combinations thereof. The food product or food replica product can be a meat replica. The meat replica can be free of animal products.

In another aspect, this document features a food product or food replica product containing (a) a heme-containing protein, and (b) a vegetable juice, a vegetable puree, a vegetable extract, a fruit juice, a fruit puree, or a fruit extract at a concentration from 0.0001% to 10% of the food product. The vegetable juice, vegetable puree, vegetable extract, a fruit juice, a fruit puree, or a fruit extract can be a Cucumis juice, puree, or extract. The Cucumis juice, puree, or extract can be from a cucumber or a melon. The vegetable juice, vegetable puree, vegetable extract, fruit juice, fruit puree, or fruit extract can have been cooked or otherwise treated to denature proteins before being added to the food replica product. For example, the vegetable juice, vegetable puree, vegetable extract, fruit juice, fruit puree, or fruit extract can have been heated to a temperature of about 60° C. to about 100° C. before being added to the food replica product. The food product can be free of animal products.

In another aspect, this disclosure features a food replica product containing one or more lactones at a concentration of 10⁻³ to 10⁻¹¹ of the food product, wherein the one or more lactones are selected from the group consisting of tetrahydro-6-methyl-2H-pyran-2-one, delta-octalactone, 5-ethyldihydro-2(3H)-furanone, butyrolactone, dihydro-5-pentyl-2(3H)-furanone, dihydro-3-methylene-2,5-furandione, 1-pentoyl lactone, tetrahydro-2H-pyran-2-one, 6-heptyltetrahydro-2H-pyran-2-one, γ-octalactone, 5-hydroxymethyldihydrofuran-2-one, 5-ethyl-2(5H)-furanone, 5-acetyldihydro-2(3H)-furanone, trans-3-methyl-4-octanolide 2(5H)-furanone, 3-(1,1-dimethylethyl)-2,5-urandione, 3,4-dihydroxy-5-methyl-dihydrofuran-2-one, 5-ethyl-4-hydroxy-2-methyl-3(2H)-furanone, δ-tetradecalactone, and dihydro-4-hydroxy-2(3H)-furanone. The one or more lactones can be 5-ethyl-4-hydroxy-2-methyl-3(2H)-furanone, butyrolactone, γ-octalactone, and δ-tetradecalactone.

In still another aspect, this disclosure features a food replica product containing one or more carotenoids at a concentration of between 0.00001% and 0.1% of the food product, wherein the one or more carotenoids are selected from the group consisting of β-carotene, zeaxanthin, lutein, trans-β-apo-8′-carotenal, lycopene, canthaxanthin, and combinations thereof.

This disclosure also features a food replica product containing a vegetable juice, a vegetable puree, a vegetable extract, a fruit juice, a fruit puree, or a fruit extract at a concentration from 0.0001% to 10% of the food product. The vegetable juice, vegetable puree, vegetable extract, fruit juice, fruit puree, or fruit extract can be a Cucumis juice, puree, or extract (e.g., a Cucumis juice, puree, or extract from a cucumber or a melon). The vegetable juice, vegetable puree, vegetable extract, fruit juice, fruit puree, or fruit extract can have been cooked or otherwise treated to denature proteins before being added to the food replica product. For example, the vegetable juice, vegetable puree, vegetable extract, fruit juice, fruit puree, or fruit extract can have been heated to a temperature of about 60° C. to about 100° C. before being added to the food replica product.

In some embodiments, the food replica products provided herein can be free of animal products, wheat gluten, soy protein, and/or tofu. Any of the food replica products provided herein can contain one or more of a plant-based meat dough, a carbohydrate-based gel, a non-animal fat, a primary esterified alkoxylated polyol binding agent, and (optionally) a secondary plant-based binding agent.

Any of the food replica products provided herein can be a meat replica. Further materials and methods for making meat replicas can be found in, for example, U.S. Publication No. 2014/0193547, and PCT publications WO 2014/110532 and WO 2014/110539, each of which is incorporated herein by reference in its entirety for all purposes.

Any of the food replica products provided herein can be a cheese replica. The cheese replica can contain a nut milk, a cross-linking enzyme, or a cheese culture. Further materials and methods for making cheese replicas can be found in, for example, U.S. Publication No. 2014/0127358, and PCT publication WO 2014/110540, both of which are incorporated herein by reference in their entirety for all purposes.

In yet another aspect, this document features a ground meat replica containing (a) a dough that contains an isolated plant protein, an optional edible fibrous component, one or more optional flavoring agents, and an optional fat; (b) a fat/primary binding agent (separately or as a blend), one or both of which contain a flavoring agent and/or an isolated plant protein; and (c) a carbohydrate-based gel, an optional secondary binding agent, a highly conjugated heterocyclic ring complexed to an iron ion and/or an iron salt, an optional edible fibrous component, and one or more optional flavoring agents. The secondary binding agent can be an isolated plant protein (e.g., a RuBisCO, an albumin, a gluten, a conglycinin, or mixtures thereof). The denaturation temperature of the binding agent can be between about 40° C. and about 80° C.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims. The word “comprising” in the claims may be replaced by “consisting essentially of” or with “consisting of,” according to standard practice in patent law.

### BRIEF DESCRIPTION OF THE DRAWINGS

FIG. 1 shows a plot of the melt profile using differential scanning calorimetry (“DSC”) of an EPG used in the examples of the present disclosure.

### DETAILED DESCRIPTION

For plant-based ground meat analogues, a typical nutrient profile can vary heavily from a real meat product, see for example, Table 1, below.

TABLE 1

Macronutrient breakdown of commercially available products
Macronutrient Profile of Various Products (Serving Size: 4 oz)

| | | | |
|---|---|---|---|
| | Ground Beef (80/20) | Plant-Based Analogue #1 | Plant-Based Analogue #2 |
| Fat | 22 g | 14 g | 18 g |
| Carb | 0 g | 9 g | 5 g |
| Protein | 19 g | 19 g | 20 g |
| Calories | 280 cal | 240 cal | 260 cal |

Typically speaking, plant-based ground-meat analogues have a much lower fat content. Part of this difference is functional, as formulation of these products, currently, requires an added carbohydrate binder that the true meat counterpart does not require. Without being bound by theory, one reason for this difference in fat content is the reduction of fat for the purpose of improving the overall health of the product as the reduction of fat lowers the total calories of the product significantly.

In general, this disclosure provides methods and materials for producing plant-based meat replicas, including ground meat replicas (e.g., ground beef, ground chicken, ground turkey, ground lamb, or ground pork), as well as replicas of cuts of meat and fish. Broadly, the disclosure provides methods for making ground meat replicas that include preparing a plant-based meat replica dough (referred to herein as “meat dough”) that includes an optional edible fibrous component, combining the meat dough with a primary binding agent comprising an esterified alkoxylated polyol (e.g., EPG) and, optionally, a fat (typically a non-animal-based fat, although it is to be noted that an animal-based fat could be used) that can optionally include a flavoring agent and/or an isolated plant protein, adding a carbohydrate-based gel, an optional edible fibrous component, an optional secondary binding agent, a highly conjugated heterocyclic ring complexed to an iron ion and/or an iron salt, and one or more flavoring agents to make the replica. After combining the meat dough with the primary binding agent, the mixture can be broken into smaller pieces before adding further ingredients.

The plant-based meat dough can incorporate an edible fibrous component to help achieve a textural heterogeneity and fibrousness in the meat replica that resembles the heterogeneity and texture of ground meat (e.g., ground beef). Incorporating flavoring agents into multiple components of the meat replica (e.g., two or more of the meat dough, the edible fibrous component, the non-animal-based fat and primary binder, or the assembled replica), helps mimic the sensory properties of ground meat. In some embodiments, flavoring agents are incorporated into three components of the meat replica. In some embodiments, flavoring agents are incorporated into four components of the meat replica.

As described herein, the flavoring agents can be flavor precursors, flavor compounds produced from reacting flavor precursors with iron, or flavorings such as extracts (e.g., a malt extract, a yeast extract, a vegetable or fruit extract, such as a cucumber extract or a melon extract, or a peptone) or protein hydrolysates such as vegetable protein hydrolysates, soy protein hydrolysates, yeast protein hydrolysates, algal protein hydrolysates, or meat protein hydrolysates or flavor compounds, natural or synthetic. Flavor precursors can react, e.g., with the iron in a highly conjugated heterocyclic ring complexed to an iron ion or an iron salt, with each other, or with flavorings, upon heating. Accordingly, in the meat replicas described herein, combinations of pre-cooked, i.e., reacted, flavor components, uncooked flavor precursors that can react (e.g., with the iron salt and/or highly conjugated heterocyclic ring complexed to an iron ion or with each other) during cooking of the replicas, or flavorings or flavor compounds that introduce a flavor without requiring a reaction, can be incorporated into the meat replica to reproduce the sensory experience of cooking and eating cooked ground meat. The flavor and/or aroma profile of the ground meat product can be modulated by the type and concentration of the flavor precursors, the pH of the reaction, the length of cooking, the type and amount of iron complex (e.g., a heme-cofactor such as a heme-containing protein, or heme bound to non-peptidic polymer or macromolecule), the temperature of the reaction, and the amount of water activity in the product, among other factors.

A highly conjugated heterocyclic ring complexed to an iron ion is referred to herein as an iron complex. Such iron complexes include heme moieties or other highly conjugated heterocylic rings complexed to an iron ion. “Heme” refers to a prosthetic group bound to iron (Fe²⁺ or Fe³⁺) in the center of a porphyrin ring. Thus, an iron complex can be a heme moiety, or a porphyrin, porphyrinogen, corrin, corrinoid, chlorin, bacteriochorophyll, corphin, chlorophyllin, bacteriochlorin, or isobacteriochlorin moiety complexed to an iron ion. The heme moiety can be a heme cofactor such as a heme-containing protein; a heme moiety bound to a non-peptidic polymer or other macromolecule such as a liposome, a polyethylene glycol, a carbohydrate, a polysaccharide, or a cyclodextrin.

In some embodiments, the iron complex is a heme-containing protein that is isolated and purified. As used herein, the term “isolated and purified” with respect to a protein or a protein fraction indicates that the protein or protein fraction has been separated from other components of the source material (e.g., other animal, plant, fungal, algal, or bacterial proteins), such that the protein or protein fraction is at least 50% (e.g., at least 55%, 60%, 65%, 70%, 75%, 80%, 85%, 90%, 95%, or 99%) free, by dry weight, of the other components of the source material.

As used herein, an “enriched” protein or protein fraction composition is at least 2-fold (e.g., at least 3-fold, 4-fold, 5-fold, 10-fold, 20-fold, 50-fold, or 100-fold) enriched in that protein or protein fraction relative to the source material.

The term “heme containing protein” can be used interchangeably with “heme containing polypeptide” or “heme protein” or “heme polypeptide” and includes any polypeptide that can covalently or noncovalently bind a heme moiety. In some embodiments, the heme-containing polypeptide is a globin and can include a globin fold, which comprises a series of seven to nine alpha helices. Globin type proteins can be of any class (e.g., class I, class II, or class III), and in some embodiments, can transport or store oxygen. For example, a heme-containing protein can be a non-symbiotic type of hemoglobin or a leghemoglobin. A heme-containing polypeptide can be a monomer, i.e., a single polypeptide chain, or can be a dimer, a trimer, tetramer, and/or higher order oligomer. The life-time of the oxygenated Fe²⁺ state of a heme-containing protein can be similar to that of myoglobin or can exceed it by 10%, 20%, 30%, 50%, 100% or more under conditions in which the heme-protein-containing consumable is manufactured, stored, handled or prepared for consumption. The life-time of the unoxygenated Fe²⁺ state of a heme-containing protein can be similar to that of myoglobin or can exceed it by 10%, 20%, 30%, 50%, 100% or more under conditions in which the heme-protein-containing consumable is manufactured, stored, handled or prepared for consumption.

Non-limiting examples of heme-containing polypeptides can include an androglobin, a cytoglobin, a globin E, a globin X, a globin Y, a hemoglobin, a myoglobin, an erythrocruorin, a beta hemoglobin, an alpha hemoglobin, a protoglobin, a cyanoglobin, a cytoglobin, a histoglobin, a neuroglobins, a chlorocruorin, a truncated hemoglobin (e.g., HbN or HbO), a truncated 2/2 globin, a hemoglobin 3 (e.g., Glb3), a cytochrome, or a peroxidase.

Heme-containing proteins that can be used in the ground meat replicas described herein can be from mammals (e.g., farms animals such as cows, goats, sheep, pigs, ox, or rabbits), birds, plants, algae, fungi (e.g., yeast or filamentous fungi), ciliates, or bacteria. For example, a heme-containing protein can be from a mammal such as a farm animal (e.g., a cow, goat, sheep, pig, fish, ox, or rabbit) or a bird such as a turkey or chicken. Heme-containing proteins can be from a plant such as Nicotiana tabacum or Nicotiana sylvestris (tobacco); Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (mung beans), Lupinus albus (lupin), or Medicago sativa (alfalfa); Brassica napus (canola); Triticum sps. (wheat, including wheat berries, and spelt); Gossypium hirsutum (cotton); Oryza sativa (rice); Zizania sps. (wild rice); Helianthus annuus (sunflower); Beta vulgaris (sugarbeet); Pennisetum glaucum (pearl millet); Chenopodium sp. (quinoa); Sesamum sp. (sesame); Linum usitatissimum (flax); or Hordeum vulgare (barley). Heme-containing proteins can be isolated from fungi such as Saccharomyces cerevisiae, Pichia pastoris, Magnaporthe oryzae, Fusarium graminearum, Aspergillus oryzae, Trichoderma reesei, Myceliopthera thermophile, Kluyveramyces lactis, or Fusarium oxysporum. Heme-containing proteins can be isolated from bacteria such as Escherichia coli. Bacillus subtilis, Bacillus licheniformis, Bacillus megaterium, Synechocistis sp., Aquifex aeolicus, Methylacidiphilum infernorum, or thermophilic bacteria such as Thermophilus spp. The sequences and structure of numerous heme-containing proteins are known. See for example, Reedy, et al., Nucleic Acids Research, 2008, Vol. 36, Database issue D307-D313 and the Heme Protein Database available on the world wide web at http://hemeprotein.info/heme.php

In some embodiments, a non-symbiotic hemoglobin can be from any plant. In some embodiments, a non-symbiotic hemoglobin can be from a plant selected from the group consisting of soybean, sprouted soybean, alfalfa, golden flax, black bean, black eyed pea, northern bean, tobacco, pea, garbanzo, moong bean, cowpeas, pinto beans, pod peas, quinoa, sesame, sunflower, wheat berries, spelt, barley, wild rice, and rice. In some embodiments, a leghemoglobin can be a soy, pea, or cowpea leghemoglobin.

In some embodiments, isolated plant proteins are used. As used herein, the term “isolated” with respect to a protein or a protein fraction (e.g., a 7S fraction) indicates that the protein or protein fraction has been separated from other components of the source material (e.g., other animal, plant, fungal, algal, or bacterial proteins), such that the protein or protein fraction is at least 2% (e.g., at least 5%, 10%, 20%, 25%, 30%, 35%, 40% 45%, 50%, 55%, 60%, 65%, 70%, 75%, 80%, 85%, 90%, 95%, or 99%) free, by dry weight, of the other components of the source material. Thus, in some embodiments, the iron complex can be a heme-containing protein (e.g., a plant heme-containing protein) that is isolated. Proteins can be separated on the basis of their molecular weight, for example, by size exclusion chromatography, ultrafiltration through membranes, or density centrifugation. In some embodiments, the proteins can be separated based on their surface charge, for example, by isoelectric precipitation, anion exchange chromatography, or cation exchange chromatography. Proteins also can be separated on the basis of their solubility, for example, by ammonium sulfate precipitation, isoelectric precipitation, surfactants, detergents or solvent extraction. Proteins also can be separated by their affinity to another molecule, using, for example, hydrophobic interaction chromatography, reactive dyes, or hydroxyapatite. Affinity chromatography also can include using antibodies having specific binding affinity for the heme-containing protein, nickel nitroloacetic acid (NTA) for His-tagged recombinant proteins, lectins to bind to sugar moieties on a glycoprotein, or other molecules which specifically binds the protein.

Methods for isolating RuBisCO from a plant are described, for example, in U.S. Pat. No. 10,798,958 (the ‘958 Patent), which is incorporated herein by reference in its entirety for all purposes. The extraction process can be improved further by adding reductants such as metabisulfite (about 2% w/v solution or more) to the initial extraction buffer and maintaining anaerobic conditions through the process and/or by adding 0.05-1% v/v cationic flocculants such as Superfloc 781G, Magnafloc LT 7989 (BASF), or Tramfloc 863A to the extraction buffer to the extraction buffer. The resuspended protein pellet from such methods, upon microfiltration at a pH of 7.0, would still perform, provide the same color, and have the same denaturation properties.

The ‘958 Patent also describes a method for isolating conglycinin (also can be referred to as a 7S fraction) from a plant such as soybean. Other sources of 7S include seeds such as, without limitation, peas, chickpeas, mung beans, kidney beans, fava beans, cowpeas, pine nuts, rice, corn, and sesame. Soluble proteins can be extracted from defatted soybean flour, and then the mixture acidified (e.g., to a pH of 4.5) to precipitate the proteins. Conglycinin can be resolubilized and concentrated, e.g., using ultrafiltration.

In some embodiments, the isolated protein is decolorized. For example, the RuBisCO concentrates can be decolorized (pH 7-9) by passing over columns packed with activated carbon. The colorants can bind to the column while RuBisCO can be isolated in the filtrate. Alternatively, RuBisCO concentrates can be decolorized by incubating the solution with a FPX66 (Dow Chemicals) resin packed in a column or batch mode. The slurry is incubated for 30 minutes and then the liquid is separated from the resin. The colorants can bind to the resin and RuBisCO can be collected in the column flow-through.

In some embodiments, a decolorized isolated plant protein can provide an increased shelf-life stability to the red color of the meat replica as compared to a corresponding meat replica including an isolated plant protein without decolorization. In some embodiments, the decolorized protein lead to an improved flavor profile of the meat replica as compared to that observed in a meat replica with the corresponding isolated plant protein without decolorization.

Heme-containing or other proteins also can be recombinantly produced using polypeptide expression techniques (e.g., heterologous expression techniques using bacterial cells, insect cells, fungal cells such as yeast, plant cells such as tobacco, soybean, or Arabidopsis, or mammalian cells). In some cases, standard polypeptide synthesis techniques (e.g., liquid-phase polypeptide synthesis techniques or solid-phase polypeptide synthesis techniques) can be used to produce heme-containing proteins synthetically. In some cases, in vitro transcription-translation techniques can be used to produce heme-containing proteins.

In some embodiments, the meat replicas described herein are substantially or entirely composed of ingredients derived from non-animal sources, e.g., plant, fungal, or microbial-based sources. In some embodiments, a meat replica may include one or more animal-based products. For example, a meat replica can be made from a combination of plant-based and animal-based sources.

### Making the Meat Replica

A meat dough can be prepared by mixing an isolated plant protein and an optional edible fibrous component, an optional flavoring agent, and a primary binding agent such as EPG (may be pre-heated to form a liquid if it is solid at production temperatures), and adding an aqueous component such as water or a broth to the mixture and kneading or otherwise mixing, manually or mechanically, to form a dough. The aqueous component can be heated before adding to the mixture of plant protein and fibrous component. In certain embodiments, once the meat dough is formed, the meat dough is heated (e.g., steamed or boiled) to a temperature ranging from 150° F. to 250° F. (e.g., 160° F. to 240° F., 170° F. to 230° F., 180° F. to 220° F., or 190° F. to 212° F.). For example, a plant-based meat dough can be steamed by placing in a rice cooker, steam cabinet, or tunnel steamer. In certain embodiments, meat dough can be heated by applying dry heat, for example, by placing in a bread maker or oven, or by immersing in hot water or broth. Boiling in broth can improve the meat dough flavor because beneficial flavors and off-flavor masking agents can be absorbed into the dough. Texture properties may also be modulated by choice of the cooking method.

As used herein, the term “isolated plant protein” indicates that the plant protein (e.g., a heme-containing protein, wheat gluten, dehydrin protein, an albumin, a globulin, conglycinin, glycinin, or a zein, or mixtures thereof) or plant protein fraction (e.g., a 7S fraction) has been separated from other components of the source material (e.g., other animal, plant, fungal, algal, or bacterial proteins), such that the protein or protein fraction is at least 2% (e.g., at least 5%, 10%, 20%, 25%, 30%, 35%, 40%, 45%, 50%, 55%, 60%, 65%, 70%, 75%, 80%, 85%, 90%, 95%, or 99%) free, by dry weight, of the other components of the source material. For example, wheat gluten can be used alone or in combination with one or more other proteins (e.g., dehydrins). Dehydrins can be particularly useful for enhancing the juiciness and texture in the ground meat replicas. In some embodiments, the meat replica can be formulated to be gluten free, and, for example, a blend of maize starch, tapioca flour, rice flour, and guar gum can be substituted for the wheat gluten in the meat dough.

The edible fibrous component can be a plant fiber, an extruded mixture of isolated plant proteins (e.g., wheat gluten or other isolated plant protein, such as glutelins, albumins, legumins, vicillins, convicillins, glycinins and protein isolates such as from any seed or bean, including soy, pea, lentil, etc.), or a solution-spun protein fiber. In some embodiments, the solution-spun protein fiber is a prolamin solution-spun protein fiber. The prolamin can be from any plant source (e.g., corn or pea) and can include zein, prolamin, kafirin, secalin, hordein, or avenin. The texture of the ground meat product (e.g., meat patty) depends on properties of the edible fibrous component such as fibrousness and tensile strength. As described herein, the extruded mixture of isolated plant proteins or solution spun protein fibers can be referred to as connective tissue replicas and the fibrousness and tensile strength of the connective tissue replicas can be controlled by co-variation of extrusion parameters such as temperature, throughput, and die size. For example, combinations of lower extrusion temperatures, medium/low throughputs and smaller dies favor production of highly fibrous tissues with low tensile strength, while higher extrusion temperatures, higher throughputs and larger dies favor production of low fibrousness tissue replicas with very high tensile strengths.

The fibrousness and tensile strength of connective tissue replicas also can be modulated by changing the composition of the extrusion mixture. For example, by increasing the ratio of isolated plant protein (e.g., soy protein such as conglycinin) to wheat gluten to 3:1 w/w, and simultaneously decreasing water content in the extrusion mixture to 50%, a connective tissue replica with thinner fibers and larger tensile strength can be made.

The texture of a meat dough also can be modified by adding cream of tartar to the preparation. For example, meat dough preparations containing cream of tartar may be more cohesive, with a form factor after grinding that is similar to ground beef, such that it is readily shaped. Cream of tartar can be added between 0.05% and 2.5% (e.g., 0.5%).

The appearance of the ground meat replica can be modulated by shredding the edible fibrous component into pieces of the desired size and shape. In some embodiments, edible fibrous component can be shredded using commercial shredders, e.g., a Cuisineart chopper/grinder, UM 12 with a dull blade attachment, Comitrol shredder (Urschel Laboratories, Indiana) or a similar shredder. The size of the fibers can be adjusted to imitate the fibrous appearance of meat by the type of shredder, choice of blade, and screen type, and adjusting the time of shredding.

In other embodiments, the edible fibrous component can be separated into fibers by carding, using hand-held carders or carding machines, for example, Pat Green carder. By varying the size and spacing of pins on the carding drums, the size of the fibers can be adjusted to imitate the fibrous appearance of meat.

In other embodiments, the edible fibrous component can be separated into fibers by pushing it through rollers (for example, a KITCHENAID® pasta attachment), followed by gentle shredding using, for example, a dull blade on a UM 12 machine. By varying the number of rollers and the spacing between the rollers, the size of the fibers can be adjusted to imitate the fibrous appearance of meat.

The fibrousness, tensile strength, and appearance of the connective tissue replicas can be tailored to imitate specific ground meat products (e.g., ground beef or different cuts of beef that can be ground).

In some embodiments, the edible fibrous component includes soluble or insoluble plant fibers. For example, plant fibers from carrot, bamboo, pea, broccoli, potato, sweet potato, corn, whole grains, alfalfa, kale, celery, celery root, parsley, cabbage, zucchini, green beans, kidney beans, black beans, red beans, white beans, beets, cauliflower, nuts, apple skins, oats, wheat, or psyllium, or a mixture thereof, can be used as the edible fibrous component.

In some embodiments, the edible fibrous component can include compounds that prevent development of off-flavors during the extrusion process. High temperature and low moisture conditions to which the extrusion mixture is exposed during the extrusion process lead to formation of compounds associated with grainy, woody, nutty, rubbery and other off-flavors. Including certain classes of compounds such as antioxidants or carotenoids can help reduce the formation of off-flavor compounds. For example, the extruded mixture can include canthaxanthin to prevent development of grainy off-flavors. Carotenoids can be about 0% to about 1% by weight of the edible fibrous component.

In some embodiments, meat doughs are formed using roughly equal proportions of isolated plant protein and edible fibrous component. It will be appreciated that the ratio can be varied as desired to tailor the properties of the end product.

In some embodiments, a broth such as a flavored broth can be used in the meat dough. For example, a meat dough can be formed using roughly equal proportions of isolated plant protein and a broth.

In some embodiments, a flavor broth includes flavor mixtures created by pre-reacting (cooking) flavor precursors before adding into the meat dough. Flavor precursor molecules or compositions can be added to a pre-reaction mixture in purified form and/or can be derived from ingredients in the uncooked meat dough that contain and/or are enriched with one or more of the particular flavor precursors or compositions, including, for example, coconut oil, cysteine, glucose, ribose, thiamine, algal oil, lactic acid, and or yeast extract. The resultant flavor and/or aroma profile can be modulated by the type and concentration of the flavor precursors, the pH of the reaction, the length of cooking, the temperature of cooking, the type and amount of iron complex (e.g., an iron containing protein, a heme cofactor such as a heme-containing protein, or ferrous chlorophyllin) or iron salt (iron gluconate), the temperature of the reaction, and the amount of water activity in the product, among other factors. The flavor broth can contain non-animal products (e.g., plant) or it can be a combination of animal and non-animal based precursors (e.g., lard). The flavor broth can bring flavors into the consumable food product that result in taste and smell of beef, bacon, pork, lamb, goat, turkey, duck, deer, yak, bison, chicken or desirable meat flavor.

In some embodiments, a flavored broth can be made by combining an iron complex (e.g., an isolated heme-containing protein) and/or an iron salt (e.g., iron gluconate, iron chloride, oxalate, nitrate, citrate, ascorbate, ferrous sulfate, ferric pyrophosphate, or any other aqueous soluble salt) with one or more flavor precursors and a fat (e.g., a non-animal-based fat), and heating the mixture to obtain a flavored broth containing one or more flavor compounds. Suitable flavor precursors include sugars, sugar alcohols, sugar derivatives, free fatty acids, triglycerides, alpha-hydroxy acids, dicarboxylic acids, amino acids and derivatives thereof, nucleosides, nucleotides, vitamins, peptides, phospholipids, lecithin, pyrazine, creatine, pyrophosphate and organic molecules. For example, sugars, sugar alcohols, sugar acids, and sugar derivatives can include glucose, fructose, ribose, sucrose, arabinose, glucose-6-phosphate, fructose-6-phosphate, fructose 1,6-diphosphate, inositol, maltose, mannose, glycerol, molasses, maltodextrin, glycogen, galactose, lactose, ribitol, gluconic acid, glucuronic acid, amylose, amylopectin, or xylose. Free fatty acids can include caprylic acid, capric acid, lauric acid, myristic acid, palmitic acid, palmitoleic acid, stearic acid, oleic acid, linoleic acid, alpha linolenic acid, gamma linolenic acid, arachidic acid, arachidonic acid, behenic acid, eicosapentaenoic acid, petroselinic acid or erucic acid. Triglycerides can include fatty acid esters of caprylic acid, capric acid, lauric acid, myristic acid, palmitic acid, palmitoleic acid, stearic acid, oleic acid, linoleic acid, alpha linolenic acid, gamma linolenic acid, arachidic acid, arachidonic acid, behenic acid, eicosapentaenoic acid, petroselinic acid or erucic acid. Amino acids and derivatives thereof can include cysteine, cystine, a cysteine sulfoxide, allicin, selenocysteine, methionine, isoleucine, leucine, lysine, phenylalanine, threonine, tryptophan, 5-hydroxytryptophan, valine, arginine, histidine, alanine, asparagine, aspartate, glutamate, glutamine, glycine, proline, serine, tyrosine, ornithine, carnosine, citrulline, carnitine, ornithine, theanine, and taurine. Phospholipids can include a plurality of amphipathic molecules comprising fatty acids, glycerol and polar groups. The fatty acids are selected from the group consisting of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, conjugated oleic acid, or esters of: oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid, or glycerol esters of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid, or triglyceride derivatives of oleic acid, palmitoleic acid, palmitic acid, myristic acid, lauric acid, myristoleic acid, caproic acid, capric acid, caprylic acid, pelargonic acid, undecanoic acid, linoleic acid, 20:1 eicosanoic acid, arachidonic acid, eicosapentanoic acid, docosohexanoic acid, 18:2 conjugated linoleic acid, or conjugated oleic acid. In some embodiments, the polar groups are selected from the group consisting of choline, ethanolamine, serine, phosphate, glycerol-3-phosphate, inositol and inositol phosphates.

Nucleosides and nucleotides can include inosine, inosine monophosphate (IMP), guanosine, guanosine monophosphate (GMP), adenosine, or adenosine monophosphate (AMP). Vitamins can include thiamine, Vitamin B2, Vitamin B9, Vitamin C, 4-aminobenzoic acid, choline, niacin, Vitamin B8, Vitamin B12, biotin, Betaine, Vitamin A, beta carotene, Vitamin D, Vitamin B6, or Vitamin E. Acids such as acetic acid, caffeic acid, glycolic acid, aspartic acid, pantothenic acid, alpha hydroxy acids such as lactic acid or glycolic acid, tricarboxylic acids such as citric acid, or dicarboxylic acids such as succinic acid or tartaric acid. Peptides and protein hydrolysates can include glutathione, vegetable protein hydrolysates, soy protein hydrolysates, wheat protein hydrolysates, corn protein hydrolysates, yeast protein hydrolysates, algal protein hydrolysates, and meat protein hydrolysates. Extracts can include a malt extract, a yeast extract, or peptone.

For example, in some embodiments, a broth can be made by combining an iron complex (e.g., an isolated and purified heme-containing protein such as leghemoglobin) and/or an iron salt (e.g., iron gluconate, iron chloride, oxalate, nitrate, citrate, ascorbate, ferrous sulfate, ferric pyrophosphate, or any other aqueous soluble salt) with one or more flavor precursors (e.g., a precursor mix shown in Table 2 or Table 13) and a fat (e.g., a non-animal-based fat), and heating the mixture to obtain a flavored broth containing one or more flavor compounds. A non-animal fat can include plant derived oils, algal oils, or oils from bacteria or fungi. Suitable plant derived oils include coconut oil, mango oil, sunflower oil, cottonseed oil, safflower oil, rice bran oil, cocoa butter, palm kernel oil, palm fruit oil, palm oil, soybean oil, rapeseed oil, canola oil, corn oil, sesame oil, walnut oil, almond oil, flaxseed, jojoba oil, castor, grapeseed oil, peanut oil, olive oil, borage oil, algal oil, fungal oil, black currant oil, babassu oil, shea butter, mango butter, wheat germ oil, blackcurrant oil, sea-buckhorn oil, macadamia oil, saw palmetto oil, conjugated linoleic oil, arachidonic acid enriched oil, docosahexaenoic acid (DHA) enriched oil, eicosapentaenoic acid (EPA) enriched oil, or margarine. The oils can be hydrogenated (e.g., a hydrogenated vegetable oil) or non-hydrogenated. Oil fractions such as stearin (e.g., palm stearin) or olein also can be used. For example, the non-animal fat can be coconut oil, or a combination of coconut oil and stearin. In some embodiments, the fat can contain non-animal (e.g., plant) products, or it can be a combination of animal and non-animal based precursors (e.g., lard), or exclusively animal-based fat.

In some embodiments, a flavored broth can be made by combining water, a non-animal based fat such as coconut oil, and a flavoring agent such as an acid (e.g., lactic acid), a carotenoid (e.g., lutein), or an antioxidant, and heating the mixture to make a broth.

After heating the meat dough as described above, a primary binding agent (and, optionally, non-animal fat), optionally containing a flavoring agent, can be combined with the meat dough. Typically, the meat dough is allowed to cool (e.g., to room temperature) before combining the meat dough with the primary binding agent and optional fat. The primary binding agent can be blended with the non-animal fat prior to combining it with the meat dough. In some embodiments, the blend may comprise 80% primary binding agent and 20% fat. In certain embodiments, the primary binder (e.g., EPG) and/or the blend of the primary binder with a fat may be pre-melted before combining with the dough if the primary binder is a solid at room temperature. Subsequently, the blend can be flavored by combining it with an iron complex or iron salt and one or more flavor precursors (described above) and heating the mixture to produce the flavor compounds. The heated mixture can be cooled so that the binding agent/fat blend can solidify. One or more additional fats (e.g., algal oil), one or more masking agents (e.g., a lactone such as butyrolactone, delta-tridecalactone, gamma decalactone, delta-dodecalactone, γ-octalactone, dihydro-5-methyl 2(3H)-furanone, 4-hydroxy-2,5-dimethyl-3(2H)-furanone, 5-ethyl-4-hydroxy-2-methyl-3(2H)-furanone, δ-tetradecalactone, or combinations thereof), or one or more flavoring compounds (e.g., acetoin, carotenoid, antioxidant, vegetable or fruit juice, puree, or extract) can be added before the mixture solidifies to improve the flavor of the primary binding agent and/or fat. In some embodiments, a combination of 5-ethyl-4-hydroxy-2-methyl-3(2H)-furanone, butyrolactone, γ-octalactone, and/or δ-tetradecalactone can be used as a masking agent. Adding one or more lactones (e.g., at a concentration of 10⁻³ to 10⁻¹) can result in a decrease in off flavors perceived as grain, eggy, bitterness, cardboard, livery, or mushroom and increase desired flavors such as creamy, buttery, caramelized, fatty, fresh, and fruity. For example, combinations of two, three, or four lactones can be used to mask properties such as bitterness. In addition, lactones also can be used at concentrations between 10⁻³ to 10⁻¹¹ to provide desired flavors such as creamy, buttery, caramelized, fatty, fresh, fruity, tallow and meaty notes to the meat replica. Thus, lactones can be used as masking agents or as flavoring agents. Lactones can act as masking agents in other products, including, without limitation, dairy replicas such as milks, cheeses, and yogurts, or protein supplements such as protein bars and protein powders. Combinations of lactones can provide a unique flavor profile important in creating meat flavors (e.g., fatty tallow and sweet aromatics) in a food product such as a meat replica or providing a beef flavor to a non-beef food product. In certain embodiments, the plant-based meat replicas improve in overall liking and meatiness rating when lactones are added to the product. In some embodiments, for example, a combination of butyrolactone, delta-tetradecalactone, and 5-ethyl-4-hydroxy-2-methyl-3(2H)-furanone can be used to provide a meaty flavor. Lactones can be added to vegetable oil to make the fat taste more like animal fat and have an increase in perception of mouth coating. The lactones also can be added to increase the sweetness of the product without a change in the sugar content. It is to be noted that agents such as lactones and carotenoids can be used to flavor food replicas (e.g., plant-based food replicas), including meat or cheese replicas, and also can be used to alter the flavor of food products such as meats and cheeses (e.g., to increase meat or cheese flavors).

In some embodiments, carotenoids such as β-carotene, zeaxanthin, lutein, trans-β-apo-8′-carotenal, lycopene, and canthaxanthin can be used to control the creation of desirable flavors and prevent undesirable flavors from being created in food products such as plant based food products (e.g., meat replicas described herein). Carotenoids can be used to reduce off plant flavors in other food products, including dairy replicas. It was found that each type of carotenoid had different properties in creating desirable flavors and controlling off flavors. See, Examples 18 and 26. The carotenoids can increase sweet and fatty notes that improve meat replicas when added between 0.00001% and 0.1%.

Carotenoids can be added to the meat replica by adding them into the flavor emulsion or the flavor broth. The carotenoids can be added before or after cooking. The carotenoids can be added between 0.00001% and 0.1%. When the carotenoids are added before cooking, they can act as a substrate in the reaction flavor mixtures creating the flavors before their addition into a meat replica. The carotenoids also change the pathway for other flavors being generated by acting as antioxidant. With the addition of carotenoids, the flavor emulsion can have improved flavor quality; there is a decrease in off oxidized notes (waxy, fishy, painty), decrease in other off notes (earthy, mushroom, grainy, beany), and an increase in sweet, fatty, meaty, and fresh flavors. Each carotenoid has different resulting flavor profiles. For example, adding lycopene to the flavor emulsion before cooking results in a bland flavor, whereas β-carotene is very flavorful with added fatty and meaty notes compared to the control. The flavor profile of adding the carotenoids before cooking has a large effect on the flavor profile. When adding carotenoids after cooking, there can still be beneficial effects especially in terms of decreasing off flavor generated with storage. Other flavor precursor molecules in the flavor emulsion or flavor broth have an impact on the effect of the carotenoids. The resultant flavor and/or aroma profile can be modulated by the type and concentration of the flavor precursors, the pH of the reaction, the length of cooking, the temperature of cooking, the type and amount of iron complex (e.g., a heme cofactor such as a heme-containing protein, or ferrous chlorophyllin) or iron salt (iron gluconate), the temperature of the reaction, and the amount of water activity in the product, among other factors, all of which change how the carotenoids change the flavor profile. Particular examples include how carotenoids can reduce or prevent the creation of flavor compounds generated in plant oils, particularly when there is metal in the oil source. Carotenoids, when added to flavor emulsions with fat and oils that have poly unsaturated fatty acids like linoleic, gamma linoleic, DHA, and EPA, can prevent off fishy, painty, and vegetable flavor notes and facilitate the generation of meatiness, and sweet notes.

Particularly carotenoids can reduce grainy, woody, earthy, mushroom, planty and oxidized notes. Carotenoids can be added to different parts of plant-based products to have different impact. Carotenoids can reduce or prevent the creation off flavor compounds generated in wheat flours including wheat gluten. For example, lutein can be added to raw meat dough and reduce overall flavor intensity, reduce grain, woody, and oxidized notes in the cooked meat dough and in the final product. These changes in flavor character is supported by reduction in particular flavor compounds as seen by SPME Gas chromatography-mass spectrometry (GC-MS) in some cases and in other cases there is no change in flavor compounds but an observed reduction in the grain character, suggesting that carotenoids act by changing chemical reactions that are taking place and by masking particular flavors. Additionally, carotenoid added to the meat dough resulted in the samples being described as more fatty and sweeter than the control without carotenoids. The main compounds that decreased with lutein included oxidized flavor compound like alcohols and aldehydes, including (Z)-2-nonenal, (E,E)-2,4-nonadienal, and 1-penten-3-ol; additionally, sulfur compounds were decreased with lutein, including methanethiol, 2-acetylthiazole, and dimethyl sulfide; many of these compounds were also described as grainy and oxidized notes by trained flavor scientist by Gas Chromatography-Olfactometry (GCO).

Antioxidants such as epigallocatechin gallate (EGCG) also can be used to reduce off flavors in food products such as plant-based products (e.g., a meat replica). Antioxidants like EGCG, which is found in (and can be purified from) green tea extracts, can be added from 0.0001% and 0.1%. Antioxidants including EGCG also can be added to meat dough and change the flavor profile of both the cooked meat dough and the consumer products created from the dough. The EGCG decreases the overall flavor of the dough and particular decreases off flavors like grainy, and oxidized flavors as described by trained flavor scientist and confirmed using GCMS.

Vegetables or fruits (juice, purees, or extracts) can be added to meat replicas to increase the perceived meat flavor (e.g., the meatiness) and likeability of the products, as well as increase the perceived fattiness and fat mouth coating. Additionally, they can cause tasters to have an increase in salivation when eating the products, leading to an increase in perceived juiciness in meat replicas. The type of meat flavors that the vegetable or fruit enhances depends on the type and processing. Examples include added tallow fatty notes from cucumber and melons that are enhanced with cooking; added sweet aromatics, char meat, and savory notes from honeydew; added sweet aromatics, and freshness from pineapple and, added savory, browned meat flavor from tomato.

The vegetable or fruit can be added to meat replicates in the form of juices, purees, extracts created from pressing, juicing, stream distillate, pressure distillation, solvent assisted flavor extraction, or other methods. The vegetable or fruit can be uncooked or untreated, or can be cooked or otherwise treated (e.g., by pasteurization or by enzyme inactivation) to denature proteins (e.g., lipoxygenase). The flavor profiles-both meatiness and amount of off notes, including green or vegetable notes of the fruit or vegetable-can change depending on cooking or other treatment, and depending on the amount and process of cooking or other treatment. Many of the flavors in fruit and vegetable extracts, purees, and juices are created by enzymes. These enzymes can create desirable or undesirable flavors, and the desired flavor depends upon the application for the extracts and juices. Selection of the appropriate type of fruit or vegetable and treatment allows the creation of flavors appropriate for meat replicas. In addition, during processing it can be desirable to deactivate enzymes that can cause off flavors. A particular enzyme that can generate off flavors in the extracts when added to meat replicates is lipoxygenase, which is particularly active in the skin of fruits and vegetables. Disruption of the skin can increase lipoxygenase activity. Therefore, enzyme inactivation before cutting the skin of the fruit or vegetable can help to reduce off flavors. In the generation of fruit and vegetable extracts, purees, or juices, the enzymes can be deactivated by heating above 60° C., high pressure pasteurization, or enzyme inhibition. In some embodiments, for example, lipoxygenase can be inhibited by the addition of inhibitors such as epigallocatechin gallate (EGCG), or by addition of other redox active enzymes. In some embodiments, the whole fruit or vegetable can be cooked or treated before penetrating the skin or cooking can occur after cutting of the product. The cooking or other treatment can be rapid (minutes) or long (hours). When cooking is used, the temperature can be slightly elevated from room temperature to under pressure above 120° C. For example, the fruit or vegetable can be cooked at a temperature of 60-100° C. (e.g., 70-80° C., 80-90° C., or 90-100° C.). The process can include blending, straining, and or pressing. The seeds can be removed in some cases or the seeds can remain.

For example, cucumber puree added to a meat replica can provide additional fatty tallow flavor but can also bring green vegetable notes along. When the fruit is cooked first, there is a decrease in a few compounds including but not limited to 2-nonenal and 2,6-nonadienal that are responsible for the green, and strong cucumber notes. Additionally, there is an increase in buttery, fatty, and tallow flavors, which could come from an increase in the concentration of lactones as seen by SPME GC-MS. The cooking of tomatoes also enhances the meaty notes while decreasing the green and tomatoes flavors.

The fruits or vegetables flavor liquids can be added to different components of the products, for example added to the meat dough before cooking, added to the fat emulsion after or before cooking, added to a gelled matrix, added to the fully assembled product, or added to the unreacted flavor broth. The extract can be added from 0.0001% for extracts to up to 10% for purees and juices.

Acids such as lactic acid can be added to the meat dough to lower the pH and change the flavor reactions that occur with cooking and processing. Beef has a pH of around 5.5; to achieve meat dough at pH 5.5 additional acidity is needed. Lactic acid brings along a desirable fresh, sourness like that seen in beef.

In other embodiments, the primary binding agent (e.g., a fat mimetic such as EPG) and/or the fat can be combined with an isolated plant protein. For example, an emulsion can be made by combining an EPG, plant derived oil, algal oil, or oil from bacteria or fungi and an optional flavor agent with an aqueous solution of an isolated plant protein (e.g., conglycinin from soy), then homogenizing the mixture using, for example, a high-speed homogenizer and heating it for a short period of time, for example, 5 min at 90° C. Physical properties of the emulsion, such as melting temperature, firmness, brittleness, color can be modulated by using different types of isolated proteins, changing the protein concentration, oil-to-water ratio, speed of homogenization, heating temperature and heating time. For example, emulsions with a high oil-to-water ratio and low protein concentration are more brittle and melt easier, while emulsions with lower oil-to-water ratio and a higher protein concentration are softer, less brittle, and more sticky, and melt at higher temperatures.

In some embodiments, an emulsion can be made by combining an EPG, plant derived oil, algal oil, or oil from bacteria or fungi and an optional flavoring agent with an aqueous solution of isolated proteins (for example, soy conglycinin) having a pH> 10 (for example, pH 12) with, for example, sodium hydroxide. Agitation, stirring or homogenization of this mixture leads to the formation of an emulsion. After the emulsion is formed, the pH can be adjusted to neutral or an acidic pH by adding, for example, hydrochloric or lactic acid. Physical properties of these emulsions can be controlled by changing protein type, protein concentration, pH level at the time of homogenization, speed of homogenization and oil-to-water ratio.

In other embodiments, an emulsion can be made by mixing an EPG, plant derived oil, algal oil, or oil from bacteria or fungi, an aqueous solution of salt and flavoring agents (e.g., flavor precursors), and emulsifiers. For example, mono/di-glycerides, lecithins, phospholipids, Tween surfactants, sodium stearoyl lactylate, or DATEM (diacetyl tartaric acid ester of monoglyceride) can be used as emulsifiers. Physical properties of these emulsions can be controlled by changing emulsifier type and concentration, speed of homogenization and oil-to-water ratio.

The solidified, optionally flavor-infused and/or protein containing EPG and, optionally, fat can be combined with the meat dough, and the mixture of the meat dough and EPG/fat can be broken into smaller pieces, e.g., by chopping, grinding, cutting, mincing, shearing, or tearing. In some embodiments, shearing can be applied to the dough while heating, resulting in a dough that firms up and eventually breaks into pieces during the cooking process. Accordingly, a separate step for breaking into pieces would not be necessary.

A carbohydrate-based gel and an optional secondary binding agent can be added to the dough-fat mixture. The carbohydrate-based gels also are useful for developing the texture of the meat replica and providing juiciness to the final product without making it soggy. Typically, carbohydrate-based gels that have a melting temperature between about 45° C. and about 85° C. are used. Non-limiting examples of suitable carbohydrate-based gels include agar, pectin, carrageenan, konjac (also known as glucomannan), alginate, chemically modified agarose, or mixtures thereof.

The secondary binding agent can be an isolated plant protein or a carbohydrate-based gel. Non-limiting examples of suitable plant proteins include RuBisCO, an albumin, a gluten, a glycinin, a conglycinin, a legumin, a globulin, a vicilin, a conalbumin, a gliadin, a glutelin, a glutenin, a hordein, a prolamin, a phaseolin, a proteinoplast, a secalin, a triticeae gluten, a zein, an oleosin, a caloleosin, a steroleosin, or mixtures thereof (e.g., albumin fractions). The plant proteins can be obtained from any source, including soy, peas or lentils. In some embodiments, useful binding agents can be obtained from a non-plant-based source. For example, egg albumin or collagen can be used as a secondary binding agent in some embodiments.

When the secondary binding agent is a protein, it is useful for the denaturation temperature of the protein to be less than the melting temperature of the carbohydrate-based gel. For example, the denaturation temperature of suitable protein-binding agents (e.g., RuBisCO, albumin, soybean conglycinin, or a gluten, or mixtures thereof) can be between about 40° C. and about 80° C. This allows the carbohydrate based gel to melt after the protein binding agent denatures and binds the meat replica together, and provides better texture and form to the meat replica.

In some embodiments, the proteins used as secondary binding agents may be chemically or enzymatically modified to improve their textural and/or flavor properties. For example, proteins may be partially proteolyzed using food-grade enzymes such as papain to result in better water-release profile during gelation and cooking. In some embodiments, the proteins used as binding agents may be chemically or enzymatically modified to modify the denaturation and gelling temperature of the proteins, for example, to achieve a specific gelling temperature (e.g., 52° C. to mimic myosin or 68° C. to mimic actin). In some instances, proteins such as proteases may be used to reduce bitterness that may be present in purified protein fractions.

In some embodiments, the secondary binding agent is a carbohydrate-based gel. For example, a carbohydrate based gel that becomes firm upon cooking to 140° F. to 190° F. (e.g., 150° F. to 180° F.). Non-limiting examples of carbohydrate-based gels include methylcellulose, modified starches such as hydroxypropylmethyl cellulose, guar gum, locust bean gum, xanthan gum, or mixtures thereof.

In addition, an iron-complex and/or an iron salt and a flavoring agent can be added to the food product. The iron-complex and/or iron salt can be the same or different than the iron-complex and/or iron salt used to flavor the meat dough, connective tissue replica, EPG primary binding agent, the fat, or an EPG/fat blend. The flavoring agent can be a flavor precursor or mixture of flavor precursors (described above) such that upon cooking the meat replica, the iron-complex and/or iron salt and flavor precursor can react and produce flavor compounds. The flavoring agent also can be a flavoring such as yeast extract, hydrolyzed protein, or a flavor compound. Flavor compounds can include, for example, phenylacetic acid, (E,E)-2,4-nonadienal, aquaresin onion, oil soluble onion, p-cresol, acetonyl acetate, 4-hydroxy-2,5-dimethyl-3(2H)-furanone, (E,E)-2,4-octadienal, 2-methyl-1-butane thiol, 2-methyl-3-furyl tetrasulfide, ethyl 2-mercaptopropionate, 2-mercapto-3-butanol (mixture of isomers), n-decane-d22, oil soluble garlic, sulfurol, sulfuryl acetate, mercapto-3-butanol, spiromeat, 1-penten-3-one, 2-methyl-3-furanthiol, 2-methyl-3-tetrahydrofuranthiol, oleic acid, dipropyl trisulfide, difurfuryl disulfide, methylcyclopentenolone, 3-methylthio hexanal, butyric acid, butyrolactone, 5-methyl-2(3H)-furanone, furaneol, 1-(1H-pyrrol-2-yl)-ethanone, hexanoic acid, and combinations thereof. Additional flavor compounds may be purchased commercially from companies such as Sigma Aldrich (St. Louis, Mo.), Penta Manufacturing Co. (Fairfield, N.J.), Advanced Biotech (Totowa, N.J.), Firmenich (Meyrin, Switzerland), Givaudan (Vernier, Switzerland), International Flavors and Fragrances (New York, N.Y.), and Wild Flavors (Erlanger, Ky.).

In some embodiments, seasonings agents such as edible salts (e.g., sodium or potassium chloride), garlic, or herbs (e.g., rosemary, thyme, basil, sage, or mint), emulsifiers (e.g., lecithin), additional fiber (e.g., zein or inulin), minerals (e.g., iodine, zinc, and/or calcium), meat shelf life extenders (e.g., carbon monoxide, nitrites, sodium metabisulfite, Bombal, vitamin E, rosemary extract, green tea extract, catechins and other antioxidants) can be incorporated into the meat replica.

Food products described herein also can include a natural coloring agent such as turmeric or beet juice, or an artificial coloring agent such as an azo dye, triphenylmethane, xanthene, quinine, indigoid, titanium dioxide, red #3, red #40, blue #1, or yellow #5, or any combination of natural and/or artificial coloring agents.

Any of the food products described herein can be shaped to the desired use, e.g., formed into patties, loaves, chubs, meatballs, or nuggets, and used in any type of food product that ground meat would be used, e.g., as taco filling, or in casseroles, sauces, toppings, soups, stews, meatballs, or meatloaves. In some embodiments, a meat replica can be formed, for example, into meatballs or nuggets, and then coated with breadcrumbs, rice, or a flour (e.g., oat flour or coconut flour) for ease of convenience.

A plant-based meat replica described herein can include about 5% to about 88% (e.g., about 10% to about 40%, about 25% to about 35%, about 40% to about 88%, or 45% to about 60%) by weight of a meat replica dough; about 0% to about 40% (e.g., about 15% to about 25%) by weight of a carbohydrate-based gel; about 0% to about 15% (e.g., about 5% to about 10%) by weight of a fat; about 1 to about 40% (e.g., about 1 to about 10%) of a primary binding agent comprising an esterified alkoxylated polyol; about 0.00001% to about 10% by weight of a flavoring agent; about 0% to about 15% (e.g., about 2% to about 15% or about 2% to about 10%) by weight of a secondary binding agent; and about 0.01% to about 4% (e.g., about 0.05% to about 1%, or about 0.2% to about 2%) by weight of an iron complex such as a heme-containing protein and/or an iron salt. The amount of flavoring agent can vary depending on the type of flavoring agent. In some embodiments, a flavoring agent can be about 0.5% to about 7% of the meat replica. For example, a flavoring agent such as a mixture of flavor precursors can be about 0.5% to about 7% of the meat replica (e.g., about 1% to about 3%; about 3% to about 6%; about 4% to about 7%). In some embodiments, a flavoring agent such as a flavoring compound can be about 0.00001% to about 2% of the meat replica.

As described herein one or more, two or more, three or more, or four or more of the components can include a flavoring agent. For example, the meat dough can include a flavoring agent (e.g., a flavoring compound produced by combining an iron complex or iron salt with one or more flavor precursors and heating) or can include a flavoring such as yeast extract in the edible fibrous component. The primary binding agent and/or non-animal fat also can include a flavoring agent (e.g., a flavoring compound produced by combining an iron complex or iron salt with one or more flavor precursors and heating). The replica also can include an iron complex or iron salt and one or more flavor precursors that can react upon cooking the replica, enhancing the sensory experience of cooking the replica. In addition, the replica can include a flavoring or flavoring compound.

In some embodiments, the components are produced at the desired particle sizes and then compressed together for 5 minutes to 24 hours (e.g., 10 minutes to 2 hours, 1 to 4 hours, 4 to 8 hours, 6 to 12 hours, or 12 to 24 hours) to allow the components to adhere into a meat replica. The meat replica may then be ground to replicate the attributes of a ground meat. The meat replica can be compressed into any desired form to replicate the shape and density of, for example, a steak, a tenderloin, a chop, or a fillet. The meat replica also may be further processed into a processed meat such as a sausage.

As described herein, in some embodiments the plant-based food products described herein comprise a primary binding agent that is derived from a fat mimetic, wherein a “fat mimetic” generally refers to a synthetic compound that mimics the taste, consistency, and mouthfeel of an animal- or plant-based fat. Fat mimetics like esterified alkoxylated polyols (e.g., EPGs) are potentially useful as a reduced calorie substitute for conventional fats and oils in food compositions. Although it is generally resistant to digestion, EPG otherwise has properties and attributes much like those of conventional triglyceride fats and oils and thus can effectively serve as a functional fat in food products. By controlling parameters such as the degree of propoxylation, the level of unsaturation and the type(s) of fatty acid acyl groups present, it is possible to tailor certain characteristics of an EPG composition such as melting point and solid fat content to make it more suitable for particular desired end-use applications.

It has been surprisingly and unexpectedly discovered by Applicant that plant-based food products can be greatly improved in terms of physical structure, binding properties, taste, fat content, and calorie content when implementing the use of a fat mimetic as a primary binding agent. Comparative plant-based food products (e.g., plant-based meat replicas) currently available in the marketplace can comprise more than 15 wt.% of fat (animal- or plant-based), in which (i) unhealthy saturated fats make up a significant portion of the fat content, (ii) fat calories account for more than 50% of the food’s calories, and (iii) manufacturers implement a significant amount of methylcellulose, a synthetic laxative, as a binder. Rather surprisingly, Applicant has found that fat mimetics such as EPG can be used to replace a significant portion of plant/animal fats used in plant-based food products, thereby significantly reducing the amount of fat and calories in the product, all while reducing the amount of undesirable binders such as methylcellulose that may need to be used. Therefore, in certain embodiments, the plant-based products described herein will comprise a calorie content in which fat contributes less than 50%, less than 40%, less than 30%, or even less than 25 wt.% of the calorie content of the product. In certain embodiments, the food product comprises less than 2% methyl cellulose, such as less than 1.5, less than 1, or even less than 0.5 wt.%, such as 0.01 to about 0.50 wt.% or, in some circumstances, 0 wt.%.

The term “esterified alkoxylated polyols” generally refers to a family of compounds comprising a polyol unit, one or more alkoxyl residues attached through the hydroxyl residue of the polyol unit, and one or more fatty acid units attached to the polyol through the alkoxyl residue. Exemplary esterified alkoxylated polyols include, but are not limited to, esterified propoxylated glycerines (EPG), including those having the following chemical structure of Formula I:

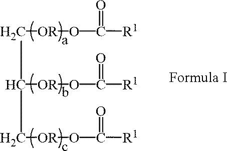

wherein R is, independently for each occurrence, selected from

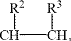

wherein R² and R³ are, independently for each occurrence, selected from hydrogen and methyl (and optionally at least one of R² and R³ is methyl), and R¹ for each occurrence is independently selected from saturated or unsaturated hydrocarbon residues. In certain embodiments, R¹ is a saturated or unsaturated, and may comprise, e.g., a hydrocarbon radical having about 1-23 carbon atoms, such as about 7-23, 12-23, or 14-23 carbon atoms. For example, in certain embodiments each R¹ may be independently selected from mixtures, such that mixtures of fatty acid residues may be found in the same molecule, or some molecules may have all one type of fatty acid residue, while other molecules in the same composition have all another type of fatty acid residue. In certain embodiments, the fatty acid residues are obtained from synthetic procedures that involve the use of fatty acids derived from natural sources, e.g., by hydrolysis of naturally occurring fats and oils such as glycerine fatty esters. Sources include animal fat, vegetable oil, etc. In some embodiments, some of the

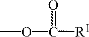

may be replaced by hydrogen, i.e., the EPG may have less than three acyl groups on average. In certain embodiments, a minor portion of the acyl groups may have R¹ which contain from 1 to 6 carbon atoms.

The degree of alkoxylation is defined as the sum of a, b, and c, where a, b, and c integers independently selected from 0 to 20. In general, a, b, and c need not be equal. It has been found, for example in certain embodiments, that when oxypropylating glycerine, a 3:1 propylene oxide/glycerine ratio (stoichiometric) will result in oxypropylation (“oxypropylation” and “propoxylation” are used synonymously) of approximately 63% of the available glycerine hydroxyl groups. In this embodiment, the majority of molecules will have one free hydroxyl group. By employing larger amounts of propylene oxide, the number of free hydroxyls decreases. In some embodiments, at a 4:1 propylene oxide/glycerine ratio. 82% of the hydroxyl groups are propoxylated, and at 5:1, propoxylation is complete. In certain embodiments, the degree of propoxylation is about 2, such as about 2.2. wherein the degree of propoxylation represents the average number of propoxylation units for EPG molecules present in the composition. In certain embodiments, the degree of propoxylation is in the range of 3 to 8, such as about 5. In certain embodiments, the degree of propoxylation is about 8 or higher. Unless stated differently, EPG molecules of the present disclosure shall be considered a fat mimetic.

In certain embodiments, following propoxylation, the propoxylated glycerine is esterified with fatty acids using conventional methods known to those of skill in the art, or transesterification of propoxylated glycerine with fatty acid alkyl (e.g., methyl) esters. Suitable EPGs for use in the methods described herein include those synthesized to have a melt point temperature of about 36° C. to about 55° C., i.e., at or somewhat above normal human body temperature, such as above 37° C. (e.g., about 39° C. or higher).

A single type of EPG may be used as the esterified propoxylated glycerol composition, or a combination of different EPGs may be used as the esterified propoxylated glycerol composition. The melt point temperature of the EPG composition may be, for example, at least 39.0° C., 39.1° C., 39.2° C., 39.3° C., 39.4° C., or 39.5° C. To achieve an EPG composition having a degree of propoxylation of at least 5 and a melt point temperature of about 39° C. or greater, esterification of a propoxylated glycerol (containing more than 8 moles of reacted propylene oxide per mole of glycerol) with a fatty acid mixture containing about 50% by weight behenic acid (C22:0) may be carried out, for example. HERO varieties naturally produce 35-45% erucic acid (C22:1), and fully hydrogenated HERO fatty acids may be enhanced with distilled behenic acid (C22:0) to obtain the desired melt point temperature.

In order to promote a further understanding of the present invention and its various embodiments, the following specific examples are provided. It will be understood that these examples are illustrative and not limiting of the invention.

### Example 1

### Preparation of Ground-Meat Substitute

Materials and Methods A blend of pea proteins with concentrations from 65% to 85 wt. % protein was obtained and hydrated to prepare a hydrated protein composition. Other dry ingredients were obtained and mixed together and were subsequently hydrated to form a hydrated binder. Hydration of the binder was performed using water or alternatively an oil in water emulsion. The hydrated protein composition was mixed with the hydrated binder, and other additional ingredients such as concentrated flavors and fat and/or EPG was added to provide a ground-meat substitute. When used, the fat and/or EPG were added after melting the same and adding as a liquid.

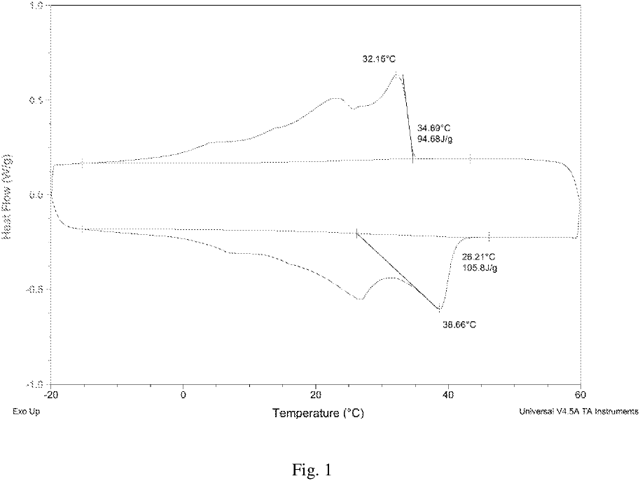

The EPG used had the following solid fat content (SFC) melting profiles shown below and in the DSC of FIG. 1.

EPG-S Typical SFC Ranges*

| Temp | Low | High |
|---|---|---|
| 10° C. | 71% | 78% |
| 20° C. | 59% | 70% |
| 25° C. | 44% | 58% |
| 30° C. | 30% | 43% |
| 35° C. | 15% | 30% |
| 40° C. | 0% | 1% |

Additionally, in certain embodiments the EPG used comprised EPG-S, otherwise known as “spreadable” EPG, which exhibits a melting temperature of 99° F. or greater, such as about 100° F. to about 104° F.

The ground-meat compositions prepared had the following ingredients as listed in Table 2 and Table 3 below by weight percentage.

TABLE 2

Formulation of EPG ground-meat substitutes

| Ingredient | Composition 1 (“50% Fat Replacement”) (wt/wt) | Composition 2 (“70% Fat Replacement”) (wt/wt) |
|---|---|---|
| Water | 56.20% | 56.20% |
| Pea Protein | 24.00% | 24.00% |
| Fat (Coconut and/or Canola oil) | 6.00% | 3.60% |
| EPG-S | 6.00% | 8.40% |
| Flavors and Colors | 5.80% | 5.80% |
| Binder | 2.00% | 2.00% |

TABLE 3

Formulation of EPG ground-meat substitutes

| Ingredient | Composition 3 (“85% Fat Replacement”) (wt/wt) | Composition 4 (“Added ‘Functional Fat’”) (wt/wt) |
|---|---|---|
| Water | 56.20% | 56.20% |
| Pea Protein | 24.00% | 20.00% |
| Fat (Coconut and/or Canola oil) | 1.80% | 12.00% |
| EPG-S | 10.20% | 4.00% |
| Flavors & Colors | 5.80% | 5.80% |
| Binder | 2.00% | 2.00% |

In Composition 1, 50% of the total of fat and EPG comprises EPG in the composition. In Composition 2, EPG comprises 70% of the total of fat and EPG in the composition. In Composition 3, EPG comprises 85% of the sum of fat and EPG in the composition.

Results: It was found that the inclusion of EPG into the formulation was most practically done by melting an EPG in the microwave and adding to the product as a liquid for incorporation during the final mixing step. EPG may also be used in the step for preparing a hydrated binder as well. When EPG is added during the final mixing step, the EPG may recrystallize into a solid upon addition. However, even after recrystallization the mechanical action of mixing easily breaks up the EPG into small chunks creating the look of a flaked fat and/or marbling within the bulk material of the product.

As the concentration of EPG was increased, the overall flavor of the ground-meat substitute was diminished. This attribute could be overcome by increasing the salt content of EPG-containing ground-meat substitutes.

It was noted that although Composition 4 had a similar appearance to the other EPG and non-EPG compositions prepared, Composition 4 cooked better and was not as easily burned during cooking and had less “burnt” and/or “bitter” notes when eaten when compared to non-EPG plant-base meat substitutes, which was a surprising unexpected benefit (in addition to the fat and caloric reduction noted below). Without being bound by theory, this observation may be related to a reduction in the smoke point when EPG is used in the preparation of the composition. The smoke point of an oil or a mixture can be described as the temperature at which it begins to decompose and subsequently vaporize. Thus, the use of coconut oil in a product seeing excess heating conditions would lend itself to a product that is burned more easily. The EPG used contained approximately 5 PO units and was esterified with long chain fatty acids of which approximately 49% were with C:18 carbons, and 44% with C:22 carbons, resulting in product’s Mettler dropping point of 102° F. used may thus lend itself to better cooking stability and subsequently less “bitter” and/or “burnt” flavor notes when compared to a product that is formulated solely with coconut and/or canola oil.

### Example 2

### Preparation of Optimized Ground-Meat Substitute

Materials and Methods: An optimized ground-meat substitute was developed to create the best eating experience as possible with the use of EPG. The same EPG that was used in Example 1 was used in this example. The composition of the formulation of this example is shown in Table 4.

TABLE 4

Composition of ground-meat substitute of Example 2

| Ingredient | Quantity |
|---|---|
| Water | 54.50% |
| Pea Protein | 20.50% |
| Fat (Coconut and/or Canola Oil) | 10.00% |
| EPG-S | 8.00% |
| Flavors and Colors | 5.90% |
| Binder | 1.10% |

Results: The product made with the composition of Example 2 maintains a lower calorie content than comparable products made without EPG, but performs more similarly to a real meat product. The nutrient profile of the composition of Example 2 is shown below in Table 5.

TABLE 5

Nutritional Information for the composition of Example 2
Nutritional Information for formulation of Example 2 Serving Size: 4 oz

| | |
|---|---|
| Nutrient | Value |
| Fat | 15 g |
| Carbohydrates | 5 g |
| Protein | 16 g |
| Calories | 220 kcal |

As a comparison, Table 6 shows the nutritional profile of various compositions including 80/20 ground beef, a control composition that does not contain EPG, and the EPG-containing compositions of Composition 2 from Example 1, and the composition of Example 2.

TABLE 6

Nutritional profile of various compositions
Nutritional Profile of Various Burger Compositions (Serving Size: 4 oz - 113 g)

| Nutrient | Ground Beef (80/20) | Control | Example 1, Composition 2 | Example 2 |
|---|---|---|---|---|
| Fat | 22 | 17 | 8 | 15 |
| Carbohydrates | 0 | 6 | 6 | 5 |
| Protein | 19 | 19 | 19 | 16 |
| Calories | 280 | 255 | 175 | 220 |

The composition of the Control from Table 6 has the composition listed in Table 7, below.

TABLE 7

Composition of Control from Table 6

| | Control Formulation (%) |
|---|---|
| Water | 56.2 |
| Pea Protein | 24 |
| Fat (Coconut and/or Canola oil) | 12 |
| Flavors and Colors | 5.8 |
| Binder | 2 |

It has been found that using EPG in a meat substitute decreased bitter and burnt notes, as well as increased the cohesion and moistness of the mass made using EPG after cooking. Other flavor characteristics may also be improved such as reduction of flavor intensities such as sweetness, beany, pea, and/or bitter taste after cooking. It was also found that the melt characteristics of EPG may impart one or more flavors or mouthfeel that is desirable in meat substitute products after cooking. For example, EPG may hide the dryness or graininess that can be associated with plant-based meat substitutes as they are consumed.

The uses of the terms “a” and “an” and “the” and similar references in the context of describing the disclosure (especially in the context of the following claims) are to be construed to cover both the singular and the plural unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and the foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

### EMBODIMENTS

The following provides an enumerated listing of some of the embodiments disclosed herein. It will be understood that this listing is non-limiting, and that individual features or combinations of features (e.g. 2, 3 or 4 features) as described in the Detailed Description above can be incorporated with the below-listed Embodiments to provide additional disclosed embodiments herein.
1. A plant-based food product comprising:
   a plant-based dough comprising an edible fibrous component; and
   a primary binder comprising an esterified alkoxylated polyol.
2. The food product of embodiment 1, further comprising a secondary binder.
3. The food product of any of the preceding claims, wherein the secondary binder comprises a plant-based carbohydrate or a plant protein.
4. The food product of embodiment 3, wherein the secondary binder comprises a plant protein.
5. The food product of embodiment 4, wherein the plant protein is selected from at least one of a RuBisCO, an albumin, a gluten, or a conglycinin.
6. The food product of any of embodiments 2-5, wherein the secondary binder comprises a carbohydrate-based gel.
7. The food product of any of embodiments 2-6, wherein the secondary binder comprises at least one of methylcellulose, hydroxypropylmethyl cellulose, guar gum, locust bean gum, or xanthan gum.
8. The food product of any of the preceding embodiments, further comprising a fat.
9. The food product of any of the preceding embodiments, further comprising a non-animal fat.
10. The food product of any of embodiments 8-9, wherein the fat comprises about 0.10 to about 10 wt.% of the food product.
11. The food product of any of embodiments 8-10, wherein the fat comprises about 0.10 to about 5 wt.% of the food product.
12. The food product of any of the preceding embodiments, wherein the primary binder comprises about 1 to about 40 wt.% of the food product.
13. The food product of any of the preceding embodiments, wherein the primary binder comprises about 1 to about 15 wt.% of the food product.
14. The food product of any of the preceding embodiments, wherein the edible fibrous component comprises a plant protein selected from at least one of a glutelin, an albumin, a legumin, a vicillin, a convicillin, a glycinin, or a prolamin.
15. The food product of any of the preceding embodiments, wherein the edible fibrous component comprises a vegetable protein.
16. The food product of any of the preceding embodiments, wherein the food product further comprises a heme-containing protein.
17. The food product of embodiment 16, wherein heme-containing protein is selected from at least one of a non-symbiotic hemoglobin, a Hell’s gate globin I, a flavohemoprotein, a leghemoglobin, a heme-dependent peroxidase, a cytochrome c peroxidase, or a mammalian myoglobin.
18. The food product of any of the preceding embodiments, further comprising a flavor agent.
19. The food product of embodiment 18, wherein the flavor agent is selected from a flavor precursor, a flavoring, or a flavor compound.
20. The food product of embodiment 18, wherein the flavor agent comprises a flavor compound selected from at least one of phenylacetic acid. (E.E)-2.4-nonadienal, aquaresin onion, oil soluble onion, p-cresol, acetonyl acetate. 4-hydroxy-2,5-dimethyl-3(2H)-furanone, (E,E)-2,4-octadienal. 2-methyl-1-butane thiol, 2-methyl-3-furyl tetrasulfide, ethyl 2-mercaptopropionate, 2-mercapto-3-butanol (mixture of isomers), n-decane-d22, oil soluble garlic, sulfurol, sulfuryl acetate, mercapto-3-butanol, spiromeat, 1-penten-3-one, 2-methyl-3-furanthiol, 2-methyl-3-tetrahydrofuranthiol, oleic acid, dipropyl trisulfide, difurfuryl disulfide, methylcyclopentenolone. 3-methylthio hexanal, butyric acid, butyrolactone, 5-methyl-2(3H)-furanone, furaneol, 1-(1H-pyrrol-2-yl)-ethanone, or hexanoic acid.
21. The food product of embodiment 18, wherein the flavor agent comprises a flavor precursor selected from at least one of alanine, arginine, asparagine, aspartate, cysteine, glutamic acid, glutamine, glycine, histidine, isoleucine, leucine, lysine, methionine, phenylalanine, proline, threonine, tryptophan, tyrosine, valine, glucose, ribose, thiamine, IMP, GMP, lactic acid, creatine, or L-taurine.
22. The food product of any of the preceding embodiments, wherein the food product comprises a fat, and the fat exhibits a melt point temperature of about 36.0° C. or lower.
23. The food product of any of the preceding embodiments, wherein the esterified alkoxylated polyol comprises an EPG.
24. The food product of embodiment 23, wherein the EPG has a melt point temperature of greater than 37.0° C. or more.
25. The food product of embodiment 23, wherein the EPG has a melt point temperature of about 37.5° C. or greater.
26. The food product of any of the preceding embodiments, further comprising a fat, wherein the fat and the primary binder exist as a blend within the food product.
27. The food product of embodiment 26, wherein blend exhibits a melt temperature that is lower than the melt temperature of the primary binder.
28. The food product of any of embodiments 26-27, wherein the blend exhibits a melt temperature that is lower than the independent melt temperatures of both the fat and the primary binder.
29. The food product of any of embodiments 26-28, wherein blend exhibits a melt temperature of about 36.0° C. or lower.
30. The food product of any of the preceding embodiments, wherein the primary binder comprises at least one EPG selected from compounds of Formula I:

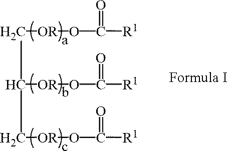

wherein R is, independently for each occurrence, selected from

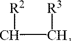

wherein
   R² and R³ are, independently for each occurrence, selected from hydrogen and methyl (and optionally at least one of R² and R³ is methyl);
   R¹ for each occurrence is independently selected from saturated or unsaturated hydrocarbon residues, such as those having about 1-23 carbon atoms, such as about 7-23, 12-23, or 14-23 carbon atoms; and
   a, b, and c are independently selected from 0 to 20.
31. The food product of embodiment 30, wherein a+b+c are an integer selected from 6 to 8.
32. The food product of any of the preceding embodiments, wherein the food product has a calorie content, and wherein a fat contributes to less than 50 wt.% of the calorie content.
33. The food product of any of the preceding embodiments, wherein the food product has a calorie content, and wherein a fat contributes to less than 40 wt.% of the calorie content.
34. The food product of any of the preceding embodiments, wherein the food product has a calorie content, and wherein a fat contributes to less than 30 wt.% of the calorie content.
35. The food product of any of the preceding embodiments, wherein the food product has a calorie content, and wherein a fat contributes to less than 25 wt.% of the calorie content.
36. The food product of any of the preceding embodiments, wherein the food product comprises less than 1 wt.% methylcellulose.
37. The food product of any of embodiments 1-35, wherein the food product comprises about 0 wt.% methylcellulose.
38. The food product of any one of the preceding embodiments, wherein the esterified alkoxylated polyol has a higher smoke point than coconut oil.
39. The food product of embodiment 23, wherein the EPG has a melt point temperature of about 37.5° C. to about 40° C.

1. A plant-based food product comprising:
a plant-based dough comprising an edible fibrous component; and
a primary binder comprising an esterified alkoxylated polyol.

2. The food product of claim 1, further comprising a secondary binder.

3. The food product of claim 2, wherein the secondary binder comprises a plant-based carbohydrate or a plant protein.

4. The food product of claim 3, wherein the secondary binder comprises a plant protein.

5. The food product of claim 4, wherein the plant protein is selected from at least one of a RuBisCO, an albumin, a gluten, or a conglycinin.

6. The food product of claim 2, wherein the secondary binder comprises a carbohydrate-based gel.

7. The food product of claim 2, wherein the secondary binder comprises at least one of methylcellulose, hydroxypropylmethyl cellulose, guar gum, locust bean gum, or xanthan gum.

8. The food product of claim 1, further comprising a fat.

9. The food product of claim 1, further comprising a non-animal fat.

10. The food product of claim 8, wherein the fat comprises about 0.10 to about 10 wt.% of the food product.

11. The food product of claim 8, wherein the fat comprises about 0.10 to about 5 wt.% of the food product.

12. The food product of claim 1, wherein the primary binder comprises about 1 to about 40 wt.% of the food product.

13. The food product of claim 1, wherein the primary binder comprises about 1 to about 15 wt.% of the food product.

14. The food product of claim 1, wherein the edible fibrous component comprises a plant protein selected from at least one of a glutelin, an albumin, a legumin, a vicillin, a convicillin, a glycinin, or a prolamin.

15. The food product of claim 1, wherein the edible fibrous component comprises a vegetable protein.

16. The food product of claim 1, wherein the food product further comprises a heme-containing protein.

17. The food product of claim 16, wherein heme-containing protein is selected from at least one of a non-symbiotic hemoglobin, a Hell’s gate globin I, a flavohemoprotein, a leghemoglobin, a heme-dependent peroxidase, a cytochrome c peroxidase, or a mammalian myoglobin.

18. The food product of claim 1, further comprising a flavor agent.

19. The food product of claim 18, wherein the flavor agent is selected from a flavor precursor, a flavoring, or a flavor compound.

20. The food product of claim 18, wherein the flavor agent comprises a flavor compound selected from at least one of phenylacetic acid, (E,E)-2,4-nonadienal, aquaresin onion, oil soluble onion, p-cresol, acetonyl acetate, 4-hydroxy-2,5-dimethyl-3(2H)-furanone, (E,E)-2,4-octadienal, 2-methyl-1-butane thiol, 2-methyl-3-furyl tetrasulfide, ethyl 2-mercaptopropionate, 2-mercapto-3-butanol (mixture of isomers), n-decane-d22, oil soluble garlic, sulfurol, sulfuryl acetate, mercapto-3-butanol, spiromeat, 1-penten-3-one, 2-methyl-3-furanthiol, 2-methyl-3-tetrahydrofuranthiol, oleic acid, dipropyl trisulfide, difurfuryl disulfide, methylcyclopentenolone, 3-methylthio hexanal, butyric acid, butyrolactone, 5-methyl-2(3H)-furanone, furaneol, 1-(1H-pyrrol-2-yl)-ethanone, or hexanoic acid.

21. The food product of claim 18, wherein the flavor agent comprises a flavor precursor selected from at least one of alanine, arginine, asparagine, aspartate, cysteine, glutamic acid, glutamine, glycine, histidine, isoleucine, leucine, lysine, methionine, phenylalanine, proline, threonine, tryptophan, tyrosine, valine, glucose, ribose, thiamine, IMP, GMP, lactic acid, creatine, or L-taurine.

22. The food product of claim 1, wherein the food product comprises a fat, and the fat exhibits a melt point temperature of about 36.0° C. or lower.

23. The food product of claim 1, wherein the esterified alkoxylated polyol comprises an EPG.

24. The food product of claim 23, wherein the EPG has a melt point temperature of greater than 37.0° C. or more.

25. The food product of claim 23, wherein the EPG has a melt point temperature of about 37.5° C. or greater.

26. The food product of claim 1, further comprising a fat, wherein the fat and the primary binder exist as a blend within the food product.

27. The food product of claim 26, wherein the blend exhibits a melt temperature that is lower than the melt temperature of the primary binder.

28. The food product of claim 26, wherein the blend exhibits a melt temperature that is lower than the independent melt temperatures of both the fat and the primary binder.

29. The food product of any of claim 26, wherein blend exhibits a melt temperature of about 36.0° C. or lower.

30. The food product of claim 1, wherein the primary binder comprises at least one EPG selected from compounds of Formula I: 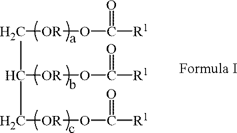
wherein R is, independently for each occurrence, selected from 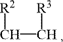
wherein
R² and R³ are, independently for each occurrence, selected from hydrogen and methyl (and optionally at least one of R² and R³ is methyl);
R¹ for each occurrence is independently selected from saturated or unsaturated hydrocarbon residues, such as those having about 1-23 carbon atoms, such as about 7-23, 12-23, or 14-23 carbon atoms; and
a, b, and c are independently selected from 0 to 20.

31. The food product of claim 30, wherein a+b+c are an integer selected from 6 to 8.

32. The food product of claim 30, wherein the food product has a calorie content, and wherein a fat contributes to less than 50 wt.% of the calorie content.

33. The food product of claim 30, wherein the food product has a calorie content, and wherein a fat contributes to less than 40 wt.% of the calorie content.

34. The food product of claim 30, wherein the food product has a calorie content, and wherein a fat contributes to less than 30 wt.% of the calorie content.

35. The food product of claim 1, wherein the food product has a calorie content, and wherein a fat contributes to less than 25 wt.% of the calorie content.

36. The food product of claim 1, wherein the food product comprises less than 1 wt.% methylcellulose.

37. The food product of claim 36, wherein the food product comprises about 0 wt.% methylcellulose.

38. The food product of claim 1, wherein the esterified alkoxylated polyol has a higher smoke point than coconut oil.

39. The food product of claim 23, wherein the EPG has a melt point temperature of about 37.5° C. to about 40° C.
